(19) United States
(12) Patent Application Publication
(10) Pub. No.: US 2025/0034313 A1
(43) Pub. Date: Jan. 30, 2025

(54) PROCESS FOR THE CONTINUOUS PRODUCTION OF AQUEOUS POLYURETHANE DISPERSIONS

(71) Applicant: BASF COATINGS GMBH, Münster (DE)

(72) Inventors: Florian SCHLUETTER, Ludwigshafen (DE); Niclas Florian ROHRBACHER, Ludwigshafen (DE); Tobias SCHOEPPING, Muenster (DE); Gerardo INCERA GARRIDO, Shanghai (CN); Martin HUFNAGEL, Lemfoerde (DE); Konrad ROSCHMANN, Ludwigshafen (DE)

(21) Appl. No.: 18/716,326

(22) PCT Filed: Dec. 19, 2022
(86) PCT No.: PCT/EP22/86576

§ 371 Date: Jun. 4, 2024

(30) Foreign Application Priority Data
Dec. 20, 2021 (EP) 21215995.8

(51) Int. Cl. C08G 18/12; C08G 18/08; C08G 18/30; C08G 18/32; C08G 18/34; C08G 18/42

(52) U.S. Cl. CPC C08G 18/12; C08G 18/0866; C08G 18/0895; C08G 18/302; C08G 18/3228; C08G 18/348; C08G 18/4202; C08G 18/4216

(57) ABSTRACT

Disclosed herein is a process for producing aqueous polyurethane dispersions having carboxyl groups. The process includes i. providing a liquid mixture of polyol compounds essentially consisting of a) at least one aliphatic diol compound a) bearing at least one carboxyl group; b) at least one polymeric polyol compound b) having on average 1.5 to 3.0 hydroxyl groups per molecule; c) optionally one or more further active hydrogen compounds; ii. continuously feeding the liquid mixture of polyol compounds provided in step i. and at least one isocyanate compound d) into a continuously operated reactor; iii. continuously discharging the polyurethane produced in step ii. from the reactor and iv. continuously dispersing the polyurethane of step iii. in water and v. optionally a chain extension or crosslinking step.

The present invention relates to a process for the continuous production of aqueous polyurethane dispersions having carboxyl groups.

Aqueous polyurethane dispersions, also termed “waterborne polyurethane dispersions” (PUDs) have gained a great significance in the field of polyurethane technology. Most commercial PUDs are prepared by a solvent based process, e.g. the so called acetone process. This process is a multi-step process comprising a first step of addition polymerization of the monomers forming the PU in an organic solvent such as acetone to obtain a solution of the PU in the solvent, a second step of emulsifying the solution of the PU in water and a third step of removing the organic solvent (acetone) by distillation, whereby the aqueous polyurethane dispersion (PUD) is obtained. A large amount of energy is consumed in this process, and some solvent still remains in the final products (about 200 ppm or higher). The residual solvent in the PUD causes high manufacturing costs and low production output. Moreover, the remaining solvent may be of ecological concern.

WO 2017/009161 describes a process for continuous production of PUDs on the basis of an acetone process which comprises continuously introducing a solution of the NCO prepolymer in acetone and an aqueous solution of a chain extension agent through a series of static mixing elements into an aqueous phase.

An alternative which avoids the drawbacks of the acetone process is the so called melt process. Here, an isocyanate terminated polyurethane prepolymer (NCO terminated prepolymer) is produced by melting the polyol monomers, mixing the melt with the isocyanate monomers to obtain a melt of the NCO terminated prepolymer, emulsifying the NCO terminated prepolymer and reacting the thus obtained aqueous emulsion of the NCO terminated prepolymer with a chain extension agent. Such melt process is described e.g. in WO 2004/052956. A major drawback of the melt process is the high reaction temperature, which makes it difficult to efficiently control the exothermic reaction of the isocyanate component with the polyol component and which adversely affect the product quality. The melt process is typically limited to the production of NCO terminated prepolymers due to the high viscosity of the prepolymer melt. Moreover, reactor fouling is a serious problem, and the shelf life of the PUDs may not be satisfactory.

DE 102017108730 describes a batch process for the production of a solvent free aqueous dispersion of a carboxylated polyurethane dispersion which comprises reacting a mixture of a polyol and 2,2-dimethylol butanoic acid (DMBA) with a first portion of a diisocyanate to obtain a first NCO terminated prepolymer, neutralizing the first NCO terminated prepolymer to obtain a second NCO terminated prepolymer, addition of the remainder of the diisocyanate to the second NCO terminated prepolymer followed by emulsifying the mixture in deionized water to obtain a prepolymer dispersion, addition of a chain extender to the prepolymer dispersion followed by homogenizing the dispersion for at least one hour. The process is time consuming and limited to a specific polyurethane composition.

WO 2019/117721 describes a process for continuously producing PUDs from NCO terminated prepolymers and chain extension agents comprising the continuous addition of a NCO terminated prepolymer and water into the mixing chamber of a high shear mixer under a turbulent mixing regime, where the chain extension agent may be fed to the water phase prior to the mixing or directly into the mixing chamber or to the dispersion of the NCO terminated prepolymer. The NCO terminated prepolymer is produced by a batch process. The aqueous phase contains emulsifiers for the stabilization of the thus obtained PUDs. A similar process is described in WO 2020/111944. These processes still have the disadvantages of the classical melt process, since the NCO terminated prepolymer is produced by a batch process.

Therefore, it is an object to provide a process for continuously producing an aqueous polyurethane dispersion of polyurethanes having carboxyl groups which overcomes the disadvantages of the prior art. In particular, the process should allow for efficiently producing aqueous dispersions of polyurethanes having carboxyl groups without requiring emulsifiers or organic solvents. In particular, the process should allow for efficiently producing PUDs of a large variety of different carboxylated polyurethanes and should not be limited to the production of an NCO terminated prepolymer which must be chain extended. Moreover, the process should result in stable PUDs.

When trying to produce PUDs by a continuous process, where the carboxylated polyurethane or the carboxylated NCO terminated prepolymer is produced in a continuous manner followed by continuously emulsifying the carboxylated polyurethane or the carboxylated NCO terminated prepolymer the inventors faced the problem that the obtained products were not particularly stable and suffered from inhomogeneity. They surprisingly found that these problems can be overcome by initially providing a liquid mixture of the required polyol compounds, wherein all components of the liquid mixture are present in mutually dissolved form, followed by feeding the liquid mixture continuously and simultaneously with at least one isocyanate compound having at least 2 isocyanate groups per molecule into a continuously operated reactor under conditions, where a polyurethane having carboxyl groups is produced.

Therefore, the present invention relates to a process for continuously producing an aqueous polyurethane dispersion of a polyurethane having carboxyl groups, said process comprising
i. providing a liquid mixture of polyol compounds essentially consisting of
   a) at least one aliphatic diol compound a) bearing at least one carboxyl group;
   b) at least one polymeric polyol compound b) having on average 1.5 to 3.0, in particular on average 1.8 to 2.5 hydroxyl groups per molecule;
   c) optionally one or more further active hydrogen compounds c) which are different from the compounds a) and b);
   wherein all components of the liquid mixture are present in mutually dissolved form;
ii. continuously feeding the liquid mixture of polyol compounds provided in step i. and at least one isocyanate compound d) having at least 2 isocyanate groups per molecule simultaneously into a continuously operated reactor under conditions, where a polyurethane having carboxyl groups is produced;
iii. continuously discharging the polyurethane produced in step ii. from the reactor and
iv. continuously dispersing the polyurethane of step iii. in water and
V. optionally a chain extension or crosslinking step.

The process is associated with several benefits. First of all, the process allows for efficiently producing aqueous dispersions of polyurethanes having carboxyl groups without requiring emulsifiers or organic solvents. The process yields stable aqueous dispersions of carboxylated polyurethanes which do not suffer from poor shelf life or inhomogeneity. Moreover, the process allows for efficiently producing PUDs of a large variety of different carboxylated polyurethanes and is not limited to the production of NCO terminated prepolymers which must be chain extended.

Here and in the following, the prefix Cₙ-Cₘ (m and m being integers) refers to the number of carbon atoms a group of radicals, a group of moieties or a group of molecules, respectively, may have. For example, the terms C₁-C₄ alkyl and C₁-C₁₀ alkyl refer to a linear or branched alkyl radical having 1 to 4 carbon atoms or 1 to 10 carbon atoms, respectively, such as methyl, ethyl, n-propyl, 2-propyl, 1-butyl, 2-butyl, isobutyl, tert.-butyl, 1-pentyl, 2-pentyl, 2-methylbutyl, 2,2-dimethylpropyl, 1-hexyl, 1-heptyl, 2-heptyl, 1-octyl, 2-ethylhexyl, n-decyl and the like. The term C₄-C₁₂ lactone refers to lactones, i.e. to internal cyclic ester of a hydroxycarboxylic acid, having 4 to 12 carbon atoms, such as gamma-valerolactone, delta-valerolactone, delta-caprolactone or epsilon-caprolactone. The term alkyleneoxide refers to an aliphatic oxirane having 2 to 4 carbon atoms, such as ethylene oxide, propyleneoxide, 1,2-butyleneoxide, 2-methylpropyleneoxide and 2,3-butyleneoxide.

The term “active hydrogen compound” refers to compounds having at least one functional group which is capable of reacting with an isocyanate group in an addition reaction, thereby forming a chemical bond between carbon atom of the isocyanate group and one of the atoms of the functional group. These functional groups are also termed “active hydrogen functional group” or “isocyanate reactive group”. Typical active hydrogen functional groups of active hydrogen compounds are the hydroxyl group (OH), the mercapto group (SH), the primary amino group (NH₂) and also the secondary amino group (NH). The aforementioned functional groups will react with isocyanate groups to form an urethane, an urea or a thiourethane group, respectively.

Here and in the following, the terms “wt.-%” and “% by weight” have the same meaning.

With respect to a composition or mixture, the terms “essentially consisting of” and essentially consist of” mean that the total amounts of the components of said composition or mixture, respectively, is at least 90% by weight, in particular at least 95%, especially at least 99% by weight or 100% by weight, based on the total weight of the composition or mixture, respectively.

Here and in the following, the term “carboxylated polyurethane” refers to a polyurethane having carboxyl groups. The amount of carboxyl groups in the carboxylated polyurethane will usually be in the range of 0.06 to 0.9 mol/kg, in particular in the range of 0.1 to 0.8 mol/kg, especially in the range of 0.15 to 0.7 mol/kg.

The carboxyl groups of the carboxylated polyurethane mainly stem from the polymerized aliphatic diol compound a). In other words, the polymerized repeating units aliphatic diol compound a) form most of the carboxyl groups in the carboxylated polyurethane. In particular, at least 90% or all of the carboxyl groups of the carboxylated polyurethane stem from the polymerized aliphatic diol compound a). The remainder of carboxyl groups may result from other ingredients, such as the polymeric polyol compound b) or from partial degradation.

Aliphatic diol compound a) are principally any aliphatic compounds which bear 2 OH groups and at least 1, e.g. 1 or 2 carboxyl groups. Their molecular weight is typically in the range of 120 to 400 g/mol. Usually, the aliphatic compound a) is selected from the group consisting of bis(hydroxymethyl)alkanoic acids, in particular from the group consisting of 2,2-bis(hydroxymethyl)-C₂-C₈-alkanoic acids, such as 2,2-bis(hydroxy-methyl)propanoic acid (hereinafter also DMPA), 2,2-bis(hydroxymethyl)butanoic acid (hereinafter also DMBA), 2,2-bis(hydroxymethyl)pentanoic acid and 2,2-bis(hydroxymethyl)hexanoic acid. In particular, the compound a) is selected from the group consisting of 2,2-bis(hydroxymethyl)propanoic acid and 2,2-bis(hydroxymethyl)butanoic acid and mixtures thereof.

In a preferred group of embodiments, the compound a) is selected from a mixture of 2,2-bis(hydroxymethyl)propanoic acid (DMPA) and 2,2-bis(hydroxymethyl)butanoic acid (DMBA). Surprisingly, the mixture has an increased solubility in the polymeric polyol compound b) and thus can be easier dissolved in the liquid mixture provided in step i. of the process of the present invention. In this mixture, the weight ratio of DMPA to DMBA is preferably in the range of 1:10 to 10:1, in particular in the range of 2 to 8 to 8:2.

The amount of the compound a) in the mixture provided in step i. is preferably such that the mixture contains 0.1 to 1 mol/kg, in particular 0.15 to 0.9 mol/kg, especially 0.2 to 0.8 mol/kg of carboxyl groups based on the total weight of the mixture. In particular, the amount of compound a) in the mixture is preferably such that the total amount of carboxyl groups is in the range of 0.06 to 0.9 mol/kg, in particular in the range of 0.10 to 0.8 mol/kg, especially in the range of 0.15 to 0.7 mol/kg based on the total weight of the mixture and the isocyanate component d) simultaneously fed into a continuously operated reactor.

Depending on the molecular weight of the compound a), the relative amount of the compound a) in the liquid mixture is generally in the range of 1.1 to 20% by weight, in particular in the range of 2 to 18% by weight and especially in the range of 3 to 15% by weight, based on the total weight of the liquid mixture provided in step i.

The liquid mixture provided in step a) further comprises at least one polymeric polyol b) having on average 1.5 to 3.0, in particular on average 1.8 to 2.5 hydroxyl groups per molecule, also termed “average OH functionality”. An average OH functionality refers to the average number of hydroxyl groups possessed by the molecules of the polymeric polyol.

The relative amount of the compound b) in the liquid mixture is generally in the range of 60 to 98.1% by weight, in particular in the range of 70 to 98% by weight or 75 to 98% by weight and especially in the range of 80 to 97% by weight or 85 to 97% by weight, based on the total weight of the liquid mixture provided in step i.

The OH number of polymeric polyol component is generally in the range from 6 to 300 mg KOH/g, in particular in the range from 10 to 200 mg KOH/g, especially in the range of 15 to 180 mg KOH/g, as determined according to DIN 53240-2:2007-11. Typically, the amount of the polymeric polyol in the liquid mixture is in the range of 80 to 98% by weight, in particular in the range of 85 to 97% by weight, based on the total weight of the liquid mixture.

Principally, any polymeric polyol conventionally used for the preparation of polyurethans can be used as polymeric polyol b). The type of polyol is of minor importance and may depend on the desired purpose of the application. Suitable polymeric polyol compounds b) are polyester polyols, including in particular aliphatic polyester polyols and aliphatic aromatic polyester polyols, polyestercarbonate polyols, polyetherester polyols, aliphatic polycarbonate polyols, polyacrylate polyols, polyolefine polyols, aliphatic polyetherols and mixtures thereof. In preferred groups of embodiments, the polymeric polyol b) is selected from polyester polyols, in particular aliphatic polyester polyols and aliphatic aromatic polyester polyols, aliphatic polycarbonate polyols, aliphatic polyetherols and mixtures thereof. In particular, the compound b) comprises a polyester polyol and/or an aliphatic polyether polyol as described herein. Especially, the compound b) is elected from polyester polyols, aliphatic polyether polyols and combinations thereof.

Generally, the polymeric polyol has a number average molecular weight in the range of 400 to 15.000 dalton, in particular in the range of 700 to 10.000 dalton and especially in the range of 1.000 to 8.000 dalton as determined by gel permeation chromatography (GPC). Typically gel permeation chromatography is carried out using tetrahydrofurane (THF) containing 0.1% by weight of trifluoroacetic acid (TFA) as eluent and polystyrene of defined molecular weight as a standard. For further details we refer to the detailed description of GPC below.

Polyesterols suitable as polymeric polyol b) are in particular aliphatic polyesterols and aliphatic/aromatic polyesterols, i.e. polyesterols which are based on a dicarboxylic acid component selected from aliphatic dicarboxylic acids, cycloaliphatic dicarboxylic acids, aromatic dicarboxylic acids and combinations and a diol component, selected from aliphatic diols and cycloaliphatic diols and polyetherpolyols.

Preferred polyester polyols have OH numbers, determined according to DIN 53240-2:2007-11, in the range from 6 to 250, in particular in the range from 10 to 200 mg KOH/g, especially in the range of 15 to 180 mg KOH/g. The acid number is preferably below 20 mg KOH/g, more particularly below 10 mg KOH/g. Preferred polyester polyols have a number average molecular weight in the range of 700 to 15.000 dalton and especially in the range of 1.000 to 10.000 dalton as determined by gel permeation chromatography as described above.

Suitable aliphatic diols for preparing the polyester polyols generally have usually 2 to 20 C atoms, in particular 3 to 10 C atoms. Examples of aliphatic diols are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptane-diol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, neopentyl glycol (2,2-di-methylpropane-1,3-diol), 2,2-diethylpropane-1,3-diol, 2-methyl-2-ethylpropane-1,3-diol, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, and tripropylene glycol.

Suitable cycloaliphatic diols for preparing the polyester polyols generally have usually 4 to 20 C atoms, in particular 5 to 10 C atoms. Examples of cycloaliphatic diols are cyclopentanediol, cyclohexane-1,4-diol, cyclohexane-1,2-dimethanol, cyclohexane-1,3-dimethanol, cyclohexane-1,4-dimethanol and 2,2,4,4-tetramethylcyclobutane-1,3-diol.

Also suitable diols for preparing the polyester polyols are polyether diols, in particular polyethylene glycols HO(CH₂CH₂O)ₙ—H, higher polypropylene glycols HO(CH[CH₃]CH₂O)ₙ—H, where n is an integer and n >4, e.g., 4 to 20, and polyethylene-polypropylene glycols, more particularly those having 4 to 20 repeating units, it being possible for the sequence of the ethylene oxide and propylene oxide units to be blockwise or random, and polytetramethylene glycols, more particularly those having 4 to 20 repeating units, and poly-1,3-propanediols, more particularly those having 4 to 20 repeating units.

Preferred dicarboxylic acids for preparing the polyester polyols are
(i) aromatic dicarboxylic acids, such as phthalic acid, isophthalic acid and, terephthalic acid,
(ii) cycloaliphatic dicarboxylic acids having preferably from 8 to 12 carbon atoms, such as tetrahydrophthalic acid, hexahydrophthalic acid, cyclohexanedicarboxylic acid, and
(iii) aliphatic dicarboxylic acids having preferably from 3 to 40 carbon atoms, such as malonic acid, succinic acid, 2-methylsuccinic acid, glutaric acid, 2-methyl-glutaric acid, 3-methylglutaric acid, a-ketoglutaric acid, adipic acid, pimelic acid, azelaic acid, sebacic acid, brassylic acid, fumaric acid, 2,2-dimethylglutaric acid, suberic acid, diglycolic acid, oxaloacetic acid, glutamic acid, aspartic acid, itaconic acid and maleic acid and dimer fatty acids, such as the dimer fatty acid of octadecadienoic acids or dimeric fatty acids obtained by dimerization of other polyunsaturated fatty acids or fatty acid mixtures [CAS 61788-89-4].

The dicarboxylic acid used in preparing the polyester polyols may be the free acids or ester-forming derivatives thereof. Derivatives are understood preferably to be the corresponding anhydrides, monoalkyl and dialkyl esters, preferably mono- and di-C₁-C₄ alkyl esters, more preferably monomethyl and dimethyl esters, and also the corresponding monoethyl and diethyl esters, and additionally monovinyl and divinyl esters, and also mixed esters, examples being mixed esters with different C₁-C₄ alkyl components.

Amongst polyester polyols preference is given to polyester polyols based on a diol component selected from the group consisting of butanediol, neopentyl glycol, hexanediol, ethylene glycol, diethylene glycol and mixtures thereof, and a dicarboxylic acid component selected from the group consisting of adipic acid, phthalic acid, isophthalic acid and combinations thereof. Particular preference is given to polyester polyols based on butanediol and/or neopentyl glycol and/or hexanediol with adipic acid and/or phthalic acid and/or isophthalic acid.

Polyester polyols suitable as polymeric polyol b) also include polylactones, in particular poly-C₄-C₁₂-lactones, especially polycaprolactones (PCL). Polylactones refer to aliphatic polyesters obtainable by ring-opening polymerization of lactones, in particular C₄-C₁₂-lactones, especially epsilon-caprolactones (e-caprolactone). Polycaprolactones have repeating monomer units of the general formula (1) [—O—CHR—(CH₂)ₘ—CO—], in which m is 4 to 10, in case of caprolactone m=4, and R is hydrogen. In the context of the invention, the term polycaprolactone is understood to mean both homopolymers of epsilon-caprolactone and copolymers of epsilon-caprolactone. Suitable copolymers are, for example, copolymers of epsilon-caprolactone with monomers selected from the group consisting of lactic acid, lactide, hydroxyacetic acid and glycolide.

The polyester polyols are customary components which are known e.g. from Ullmanns Encyklopädie der technischen Chemie [Ullmann's Encyclopedia of Industrial Chemistry], 4th edition, volume 19, pp. 62 to 65.

Aliphatic polyether polyols suitable as polymeric polyol b) are, for example, the polyaddition products of C₂-C₄-alkylene oxides, such as ethylene oxide, propylene oxide, 1,2-butylene oxide, 2,3-butylene oxide or 2-methylpropylene oxide. Further suitable polymeric polyols b) are aliphatic polyether polyols obtainable by condensation of polyhydric aliphatic alcohols, aliphatic polyether polyols obtained by alkoxylation of aliphatic polyhydric alcohols, amines and amino alcohols. Suitable polyhydric alcohols include ethylene glycol, 1,2-propylene glycol, 1,3-propylene glycol, 1,4-butanediol, neopentyl glycol, 1,6-hexanediol, trimethylolpropane, glycerol, pentaerythritol, triethanolamine (=tris(2-hydroxyethyl)amine), sorbitol or mixtures of these. Suitable polyetherols have generally OH functionalities in the range of 1.5 to 3.0, in particular in the range of 1.8 to 2.5. Suitable polyetherols have preferably OH numbers in the range of 20 to 300 mg KOH/g and in particular in the range of 30 to 250 mg KOH/g. Generally, they have number average molecular weights Mn in the range of 400 to 10.000 g/mol, preferably of 500 to 8.000 g/mol, determined by gel permeation chromatography as described above. Preferred polyether components b) are polyethylene oxide polyols, polypropylene oxide polyols and polytetramethylene oxide polyols (poly-THF) having a molecular weight Mn of 400 to 10.000 g/mol, preferably of 500 to 8.000 g/mol. In this case, the polyether polyols of particularly low molecular weight may be water-soluble in the case of correspondingly high OH contents.

Aliphatic polycarbonate polyols suitable as polymeric polyol b) are obtainable by reaction of carbonic acid derivatives, for example diphenyl carbonate, dimethyl carbonate or phosgene, with diols. Useful diols of this kind include, for example, ethylene glycol, propan-1,2- and -1,3-diol, butane-1,3- and 1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, but also lactone-modified diols. The diol component preferably contains 40% to 100% by weight of hexane-1,6-diol and/or hexanediol derivatives, preferably those having ether or ester groups as well as terminal OH groups, for example products which are obtained by reaction of 1 mol of hexanediol with at least 1 mol, preferably 1 to 2 mol, of E-caprolactone or by etherification of hexanediol with itself to give di- or trihexylene glycol. It is also possible to use polyether polycarbonate polyols. Amongst aliphatic polycarbonate polyols preference is given to polycarbonate polyols based on dimethyl carbonate and hexanediol and/or butanediol and/or E-caprolactone. Very particular preference is given to polycarbonate polyols based on dimethyl carbonate and hexanediol and/or ε-caprolactone. Preferred polycarbonate polyols have a molecular weight Mn of 400 to 10.000 g/mol, preferably of 500 to 8.000 g/mol, determined by gel permeation chromatography as described above.

The liquid mixture provided in step i. may contain one or more further active hydrogen compounds c) which are different from the compounds a) and b). Generally, said active hydrogen compounds c) have a molecular weight of at most 400 g/mol. Suitable active hydrogen compounds c) may have 1, 2, 3 or 3 and preferably have 2 functional groups capable of reacting with the isocyanate group, which are in particular selected from OH, NH₂ or SH. In particular, the compounds c) are selected compounds having a molecular weight of at most 400 g/mol and having 2 OH groups pre molecule as sole functional groups.

In particular, the active hydrogen compounds c) are selected from
aliphatic diol compounds having 2 to 20 carbon atoms, for example ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, hydroxypivalic acid neopentyl glycol ester, 1,2-, 1,3- and 1,4-butanediol, 1,6-hexanediol, 1,10-decanediol, 2-ethyl-1,3-hexanediol, 2,4-diethyloctane-1,3-diol,
cyclic aliphatic diol compounds having 3 to 14 carbon atoms, for example tetramethylcyclobutanediol, 1,2-, 1,3- and 1,4-cyclohexanediol, 1,1-, 1,2-, 1,3- and 1,4-cyclohexanedimethanol, 1,2-, 1,3- or 1,4-cyclooctanediol, norbornanediol, pinanediol, decalindiol, 2,2-bis(4-hydroxycyclohexyl)propane, bis(4-hydroxycyclohexane)isopropylidene; and
aliphatic aminoalcohols having 2 to 20 carbon atoms, such as monoethanolamine, diethanolamine, monopropanolamine, dipropanolamine, N-methyl diethanolamine and N-methyl dipropanolamine.

Particular preference is given to compounds c) which are selected from aliphatic diols having 2 to 12 carbon atoms such as 1,4-butanediol, 1,5-pentanediol and neopentyl glycol.

Preferably, the amount of the active hydrogen compounds c) does not exceed 20% by weight, in particular 10% by weight, especially 5% by weight, based on the total weight of the liquid mixture. If present, the amount of the active hydrogen compounds c) is in the range of 0.1 to 20% by weight, in particular 0.2 to 10% by weight, especially 0.5 to 5% by weight, based on the total weight of the liquid mixture.

Preferably, the liquid mixture of polyol compounds provided in step i. contains less than 10% by weight, in particular at most 5% by weight, especially at most 1% by weight or 0% by weight, based on the total weight of the liquid mixture, of compounds having only one active hydrogen group per molecule.

Preferably, the liquid mixture of polyol compounds provided in step i. contains less 10% of organic compounds which do not have any active hydrogen functional group and which thus are inert under reaction conditions. These compounds typically have a molecular weight of at most 200 g/mol and are also termed “organic solvent”. Examples of organic solvents include, but are not limited to, ketones having 3 to 8 carbon atoms, in particular aliphatic or cycloaliphatic ketones having 3 to 8 carbon atoms, such as acetone, methylethyl ketone, cyclohexanone and isobutylmethyl ketone, and aliphatic or alicyclic ethers, e.g. tetrahydrofurane, dioxane or di-C₁-C₄-alkyl ethers of mono-, di- or trialkylene glycols, such as diethyleneglycol dimethyl ether, triethyleneglycol dimethyl ether, dipropyleneglyocl dimethyl ether, tripropyleneglycol dimethyl ether, esters, e.g. C₄-C₈ lactones, such as butyrolactone, valerolactone or caprolactone, aliphatic etheresters, e.g. C₁-C₄ alkoxy-C₂-C₄ alkyl acetates and propionates, such as methoxypropyl aceate, or carbonates, such as ethylene carbonate, dimethyl carbonate, diethyl carbonate, N-alkyl-2-pyrrolidones, such as N-methyl-2-pyrrolidone, N-ethyl-2-pyrrolidone or higher homologues, and mixtures thereof. In particular, the liquid mixture of polyol compounds provided in step i. does not contain any organic compound which does not have any active hydrogen functional group or contains less 2% by weight of said compounds.

The liquid mixture of polyol compounds provided in step i. essentially consists of the components a), b) and optionally c), which means that the total amounts of the components a), b) and optionally c) is at least 90% by weight, in particular at least 95%, especially at least 99% by weight, based on the total weight of the composition or mixture, respectively.

In particular, the liquid mixture of polyol compounds provided in step i. consists to at least 90% by weight, in particular at least 95% by weight, especially at least 99% by weight, based on the total weight of the liquid mixture, of the compounds a) and b).

The liquid mixture may contain a catalyst which catalyzes the polyurethane formation of the reactive components a), b) and optionally c) contained in the liquid mixture with the isocyanate compound. The amount of catalyst will be typically not exceed 1% by weight, based on the total weight of the liquid mixture and is typically in the range of 0.1 to 1% by weight. Suitable catalysts include, but not limited to, tin compounds such as tin octoate, dibutyltin dilaurate, bismuth neodecanoate or bismuth dioctoate, and tertiary amines such as dimethylbenzylamine, trimethylamine, 1,4-diazabicyclo[2.2.2]octane or any other catalyst known to the person skilled in the art which furthers the formation of urethane groups by the reaction of the hydroxyl groups in compounds a) and b) with the isocyanate groups of the isocyanate compound d). Further catalysts are described in, for example, Houben-Weyl, Methoden der Organischen Chemie, Vol. XIV/2, Thieme-Verlag, Stuttgart 1963, p. 60f. and also Ullmanns Enzyklopädie der Technischen Chemie, 4th edn., Vol. 19 (1981), p. 306.

In step i. a liquid mixture is provided, wherein the compounds a), b) and optionally c) are mutually dissolved in each other. In this context, the term “mutually dissolved” means that the liquid mixture is virtually homogeneous and does not have visible inhomogeneity. In other words, the liquid mixture is visually transparent to human eye. For this, step i. generally comprises mixing the compounds a), b) and optionally c) and heating the thus obtained mixture until the compounds are mutually dissolved in each other. Mixing and heating can be done simultaneously or consecutively. Typically heating requires temperatures of at least 60° C., in particular at least 70° C., especially at least 90° C., e.g. in the range of 60 to 250° C., in particular in the range of 70 to 160° C., especially in the range of 90 to 140° C. The time for achieving mutual dissolution of the components of the liquid mixture may vary and depend on the temperature. A skilled person will easily find out suitable conditions for achieving mutual dissolution of the components of the liquid mixture by routine. The time for achieving mutual dissolution is typically in the range of 5 minutes to 180 minutes. The dissolution may be carried out in a continuous manner or batch-wise. For example, dissolution is carried out in a continuously or batch-wise operated stirred tank reactor heated to the temperature required for complete mutual dissolution of the components of the liquid mixture.

Generally, the liquid mixture provided in step i. does not contain more than traces of water, in order to avoid undesirable side reactions of the isocyanate groups of the compound d). Preferably, the water content of the liquid mixture provided in step i. is less than 0.5% by weight, in particular less than 0.3% by weight, based on the total weight of the liquid mixture and may be as low as 0.1% by weight or even lower. The water content of the liquid mixture can be determined e.g. by Karl Fischer titration, e.g. according to the protocol of DIN EN ISO 15512:2019.

In step ii., the liquid mixture of polyol compounds provided in step i. and at least one isocyanate compound d) are fed simultaneously into a continuously operated reactor under reaction conditions, where the reactive functional groups of the components of the liquid mixture of step i. react with the isocyanate groups of the isocyanate compound d). Thereby, a polyurethane having carboxyl groups is produced.

For the purpose of the present invention, principally any isocyanate compounds having at least 2 isocyanate (NCO) groups per molecule can be employed in step ii). This compound is hereinafter also referred to as “polyisocyanate c)”. That is, to say, the at least one polyisocyanate d) comprises a plurality of NCO functional groups, e.g. 2, 3 or 4 NCO functional groups, or any value or ranges of values therein. It is to be understood that the at least one polyisocyanate c) includes both monomeric diisocyanates, i.e. compounds having 2 NCO functional groups isocyanates, and oligomeric forms thereof having on average more than 2 NCO functional groups, e.g. from 2 to 4 NCO functional groups.

The at least one polyisocyanate d) typically has an NCO content in the range of 10 to 50 wt.-%, preferably in the range of 15 to 45 wt.-%. Determination of the NCO contents on percent by weight is accomplished by standard chemical titration analysis known to those skilled in the art and, therefore, the present invention is not limited by any such methods.

For the purpose of the present invention, the at least one polyisocyanate d) is preferably selected from the group consisting of aliphatic diisocyanates d1), alicyclic diisocyanates d2) and aromatic diisocyanates d3).

The term “aliphatic diisocyanate d1)” refers to molecules having two isocyanate groups attached to an acyclic saturated hydrocarbon radical which typically comprises 4 to 18 carbon atoms. Examples of aliphatic diisocyanates d1) include, but are not limited to, tetramethylene-1,4-diisocyanate, pentamethylene-1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, etc., and mixtures thereof.

Preferred aliphatic diisocyanates d1) are pentamethylene-1,5-diisocyanate, hexamethylene-1,6-diisocyanate, 2,2,4-trimethyl-hexamethylene-1,6-diisocyanate and 2,4,4-trimethyl-hexamethylene-1,6-diisocyanate, and mixtures thereof.

The term “alicyclic diisocyanate d2)” refers to molecules having two isocyanate groups attached to a saturated hydrocarbon radical bearing at least one cyclic moiety. Alicyclic diisocyanate d2) typically comprises 6 to 18 carbon atoms. Examples of alicyclic diisocyanates d2) include, but are not limited to cyclobutane-1,3-diisocyanate, 1,2-, 1,3- and 1,4-cyclohexane diisocyanate, 2,4- and 2,6-diisocyanato-1-methylcyclohexane (=2,4- and 2,6-hexahydrotoluenediisocyanate), 4,4′- and 2,4′-dicyclohexyl-diisocyanates, isocyanatomethylcyclohexane isocyanate, isocyanatoethylcyclohexane isocyanates, bis(isocyanatomethyl)cyclohexane, 4,4′-diisocyanatodicyclohexylmethane (12-MDI), isophorone diisocyanate and mixtures thereof. Preferred alicyclic diisocyanates d2) are 1,2-, 1,3- and 1,4-cyclohexane diisocyanate, 2,4- and 2,6-diisocyanato-1-methylcyclohexane, 4,4′- and 2,4′-dicyclohexyldiisocyanates, bis(isocyanatomethyl)cyclohexane, 4,4′-diisocyanatodicyclohexylmethane (12-MDI), isophorone diisocyanate and mixtures thereof. The isophorone diisocyanate is frequently a mixture, specifically a mixture of the cis and trans isomers, generally in a mass ratio of 60:40 to 80:20, more particularly in a ratio of 70:30 to 75:25, and particularly especially in a ratio of about 75:25.

The term “aromatic diisocyanate d3)”, refers to molecules having two isocyanate groups attached directly and/or indirectly to the aromatic ring. Aromatic diisocyanates d3) typically have 8 to 18 carbon atoms. Examples of aromatic diisocyantes include, but are not limited to, 1,2-, 1,3-, and 1,4-phenylene diisocyanates, naphthylene-1, 5-diisocyanate, 2,4- and 2,6-toluene diisocyanate, 2,4′-, 4,4′- and 2,2′-biphenyl diisocyanates, 2,2′-, 2,4′- and 4,4′-diphenylmethane diisocyanate, 1,2-, 1,3- and 1,4-xylylene diisocyanates and m-tetramethylxylyene diisocyanate (TMXDI), and mixtures thereof. Preferred aromatic diisocyanates d2) are 2,4- and 2,6-toluene diisocyanate, 2,4′-, 4,4′- and 2,2′-biphenyl diisocyanates, 2,2′-, 2,4′- and 4,4′-diphenylmethane diisocyanate, 1,2-, 1,3- and 1,4-xylylene diisocyanates and m-tetramethylxylyene diisocyanate (TMXDI) and mixtures thereof.

Preferably, the isocyanate compound d) comprises at least one of alicyclic diisocyanate compounds d2) and aromatic diisocyanate d3). In particular, the isocyanate compound d) fed into the reactor is selected from alicyclic diisocyanate compounds d2), aromatic diisocyanate compounds and mixtures thereof with aliphatic diisocyanate compounds d1). More preferably, the isocyanate compound d) comprises at least one of
(i) alicyclic diisocyanate compounds d2), selected from 1,2-, 1,3- and 1,4-cyclohexane diisocyanate, 2,4- and 2,6-diisocyanato-1-methylcyclohexane, 4,4′- and 2,4′-dicyclohexyldiisocyanates, bis(isocyanatomethyl)cyclohexane, 4,4′-diisocyanatodicyclohexylmethane (12-MDI), isophorone diisocyanate and mixtures thereof, in particular selected from 2,4- and 2,6-diisocyanato-1-methylcyclohexane, 4,4′- and 2,4′-dicyclohexyldiisocyanates, bis(isocyanatomethyl)cyclohexane, 4,4′-diisocyanatodicyclohexylmethane (12-MDI), isophorone diisocyanate and mixtures thereof, especially selected from bis(4-isocyanatocyclohexyl)methane, isophorone diisocyanate and mixtures thereof;
(ii) and aromatic diisocyanate d3) selected from 2,4- and 2,6-toluene diisocyanate, 2,4′-, 4,4′- and 2,2′-biphenyl diisocyanates, 2,2′-, 2,4′- and 4,4′-diphenylmethane diisocyanate, 1,2-, 1,3- and 1,4-xylylene diisocyanates and m-tetramethylxylyene diisocyanate (TMXDI) and mixtures thereof, in particular selected from 2,4- and 2,6-toluene diisocyanate, 2,2′-, 2,4′- and 4,4′-diphenylmethane diisocyanate, 1,2-, 1,3- and 1,4-xylylene diisocyanates and mixtures thereof, especially selected from 2,4- and 2,6-toluene diisocyanate, 4,4′-diisocyanatodiphenylmethane and mixtures thereof.

Preferably, the total amount of the diisocyanates d2) and d3) is at least 60 wt.-%, in particular at least 70 wt.-% or 100 wt.-%, based on the total weight of the isocyanate compound d) fed into the reactor. If present, the amount of the aliphatic diisocyanate compounds d1 does not exceed 40 wt.-%, in particular 30 wt.-%, based on the total weight of the isocyanate compound d) fed into the reactor and may be in the range of 1 to 40 wt. % or 1 to 30 wt.-%.

Especially, the isocyanate compound is selected from toluene diisocyanate, 4,4′-diisocyanatodiphenylmethane, bis(4-isocyanatocyclohexyl)methane, isophorone diisocyanate, mixtures thereof and mixtures thereof with hexamethylene diisocyanate. Preferably, the total amount of the toluene diisocyanate, 4,4′-diisocyanatodiphenyl-methane, bis(4-isocyanatocyclohexyl)methane and isophorone diisocyanate is at least 60 wt.-%, in particular at least 70 wt.-% or 100 wt.-%, based on the total weight of the isocyanate compound d) fed into the reactor.

In the isocyanate compound d) a small portion of the diisocyanate may be replaced by isocyanate compounds having more than 2 isocyanate groups per molecule. Preferably, the amount of such isocyanate compounds does not exceed 10% of the total amount of isocyanate compounds d).

The relative amount of the isocyanate compounds d) is preferably chosen such that the molar ratio of NCO groups in the at least one compound d) fed to the reactor to isocyanate-reactive groups (IR groups), i.e. active hydrogen groups, present in the liquid provided in step i. may vary depending on whether an NCO terminated polyurethane or a polyurethane having virtually no NCO groups shall be prepared. Generally, the molar ratio of NCO groups to IR groups is in the range of 0.6:1 to 3.0:1, preferably in the range of 0.7 to 2.0:1, more preferably in the range of 0.75:1 to 1.8:1. Obviously, a molar ratio NCO groups to IR groups of >1 will result in polyurethanes having NCO groups, while a molar ratio NCO groups to IR groups of at most 1:1 will result in polyurethanes having virtually no NCO groups, i.e. an NCO content of less than 0.2% by weight, based on the polyurethane, or even below the detection limit.

The liquid mixture of polyol compounds provided in step i. and the at least one isocyanate compound d) are continuously fed into the continuously operated reactor. Feeding may be carried out either via separate feed lines or as a preformed mixture of the liquid mixture of polyol compounds provided in step i. and the at least one isocyanate compound d). Preferably, the liquid mixture of polyol compounds provided in step i. and the at least one isocyanate compound are mixed followed by continuously feeding the mixture into the continuously operated reactor. For mixing, a dynamic mixing element or a static mixing element can be used, with preference given to the latter.

Mixing of the liquid mixture of polyol compounds provided in step i. and the at least one isocyanate compound d) is preferably achieved by continuously feeding the isocyanate compound d) and liquid mixture of polyol compounds to a mixing element, in particular a static mixing element. Preferably, mixing is carried out at elevated temperatures, e.g. at a temperature of at least 50° C., in particular at a temperature in the range of 50 to 120° C. For this, it may be beneficial to preheat the isocyanate compound d) or heat the feed line of the isocyanate compound d) and mix the preheated isocyanate compound d) with the still hot liquid mixture of polyol compounds provided in step i. Typically, the residence time of components continuously fed into the mixer is in the range of 5 to 120 seconds to achieve the mixing, before the mixture is continuously discharged from the mixer and fed into the reactor.

As mentioned above, mixing is preferably carried out in a static mixer. Unlike dynamic mixing devices or dynamic mixers, which are marked by the presence of an external force for agitating the fluids to be mixed, the static mixing devices or static mixers provide adequate mixing through their flow geometry. Typical examples of a dynamic mixer include, such as but not limited to, a stirred tank vessel. In contrast thereto, static mixers utilize the kinetic energy of the fluid itself for mixing. Thus, concentration equalization is achieved solely by the flow through the mixer in the case of static mixers. Static mixers operate largely according to the principle of lamination, chaotic advection or production of turbulent eddy detachments. Preferably, mixing is achieved in the laminar regime. Principally, the static mixer may exist in any shape, size and/or dimension. Preference is given to static mixers having a tubular flow duct, i.e. static mixers in the form of tubes including static mixing elements arranged in the flow duct and having a diameter substantially corresponding to the inner diameter of the flow duct. The type of static mixer is of minor importance and may be an X-type mixer, such as a CSE-X mixer, or HSM mixer (High Shear Mixer), a roof disc mixer or double roof disc mixer or a helical mixer. For further details of static mixers reference is made to the description of static mixers below. The static mixer may be arranged horizontally or vertically.

The liquid mixture of polyol compounds provided in step i. and the at least one isocyanate compound d), preferably in the form of a preformed mixture, are then continuously fed into the continuously operated reactor. In particular, the mixture of the isocyanate compound d) and the liquid mixture obtained in step i. is continuously discharged from the mixer and immediately fed into the continuously operated reactor.

The reactor is operated under conditions which result in polyurethane formation. These conditions are essentially the reaction temperature in the reactor required for the reaction of the isocyanate groups with the active hydrogen groups of the compounds present in the reactor as well as the residence time required achieving complete or almost complete turnover of the components present in the reactor. Generally, the reactor is operated under conditions that a turnover of at least 50%, in particular at least 75% of the theoretical value is achieved. For example, the turnover may be higher than 95% based on the theoretical value, in particular if an OH terminated polyurethane shall be produced. Lower turnovers may be possible if NCO terminated polyurethane compounds shall be produced. The turnover refers to the consumption of NCO groups in the reaction mixture.

The reaction conditions for polyurethane formation will depend on the reactivity of the components present in the liquid mixture provided in step i., the reactivity of the isocyanate compound d) and the presence or absence of a catalyst. Generally, the reaction temperature is in the range of 60° C. to 200° C., in particular in the range of 80 to 170° C. The residence time is typically in the range of 5 min. to 240 min. and in particular in the range of 10 min. to 45 min. A skilled person will find suitable reaction conditions by carrying out routine experiments.

The reaction of the isocyanate compound d) with the compounds a), b) and optionally c) contained in the liquid mixture of step i. is exothermic. Therefore, the reactor may comprise means for dissipation of the reaction heat and means for controlling the reaction temperature. For example, the reactor may comprise a heat exchanger, e.g. a mantle filled with a heat transfer fluid, in order to preheat or cool the reactor to the desired reaction temperature.

In particular, it was found beneficial, if the reactor comprises at least two reaction zones operated at different temperatures. In particular, the reaction zone adjacent to the feeding point is operated at a lower temperature than the reaction zone adjacent to the discharge point. In particular, the zone adjacent to the feeding point is operated at a temperature which is at least 10 K, e.g. 10 to 100 K lower than the temperature of the reaction zone adjacent to the discharge point. For example, the reaction zone adjacent to the feeding point is operated at a temperature in the range of 60 to 130° C., while the reaction zone adjacent to the discharge point is operated at a temperature in the range of 90 to 200° C. or 90 to 180° C.

The formation of the polyurethane may be promoted or accelerated by a suitable catalyst as mentioned above. The catalyst may be charged into the reactor via a separate feedline, as a mixture with the isocyanate compound d) fed to the reactor, or, if the liquid mixture provided in step i. and the isocyanate compound d) are previously mixed, to the mixer. Preferably, the catalyst is included in the liquid mixture provided in step i., which is either fed via a separate feedline into the reactor or as a mixture with the isocyanate compound d) as described above or as a mixture with the polymeric compound b) as described above. If present, the concentration of the catalyst in the reaction mixture is generally in the range of 0.01 to <1 wt.-%.

Principally, the reactor for carrying out step ii. of the inventive process may be any type of continuously operated reactor suitable for reacting liquids. For example, the reactor may be a continuously operated stirred tank reactor or a cascade of continuously operated stirred tank reactors.

Preferably, step ii. is carried out in a tubular reactor. In contrast to a stirred tank, the tubular reactor has a longitudinal geometry, wherein the length is a multiple of its diameter, or the volume is a multiple of the cross-sectional area. The tubular reactor does not necessarily have its total length in the same inner diameter. Rather, the tubular reactor may have sections with different inner diameters, which may vary by a factor of 1:5. Generally, the ratio of the length of the tubular reactor to its average diameter is at least 5:1 or at least 10:1, e.g. in the range of 5:1 to 1000:1, in particular in the range of 10:1 to 500:1. The tubular reactor may be arranged horizontally or vertically.

In particular, step ii. is carried out in a tubular reactor which comprises at least one static mixing element located in the interior of the tubular reactor. Usually, such a mixing element is arranged in the flow duct and has a diameter substantially corresponding to the inner diameter of the flow duct. In particular, the tubular reactor comprises a plurality of static mixing elements. The static mixing elements arranged in the interior of the tubular reactor ensure both a uniform mixing of the reactants and a uniform heat distribution within the reaction mixture, thereby reducing the risk of overheating and thus the risk of fouling.

Frequently, the mixing element comprises at least one of the following elements or a combination thereof:
(i) a plurality of webs or perforated plates which are arranged in a crossed fashion and being arranged in two intersecting plane groups each of which having a multiplicity of planes arranged parallel to one another and inclined with respect to the flow direction thereby forming a grid like structure with ducts through which the fluids to be mixed will pass;
(ii) a plurality of perforated folded plates with circular or longitudinal openings, the main plain of the folded plates being oriented almost perpendicular to the flow direction;
(iii) a plurality of helically formed plates or helical rods, whose main axis is oriented in parallel to the flow direction.

Static mixers having mixing elements (i) are often called X-mixers, including CSE-X mixers and SMX mixers, or HSM mixers (High Shear Mixers). These types of static mixers and have been described e.g. in U.S. Pat. Nos. 4,201,482, 5,620,252, 4,692,030, US 2010/202248, US 2011/0080801, EP 1067352, EP 2286904, EP 1067352. They are commercially available from different producers, e.g. from Fluitec AG, StaMixCo Technology AG and JLS International. Static mixers having mixing elements (ii) are sometimes called roof disc mixers or double roof disc mixers and have been described e.g. in DE 19837671 and WO2007/110316. They are commercially available from different producers, e.g. from StaMixCo Technology AG and JLS International. Static mixers having mixing elements (iii) are often called helical mixers. They are well known and e.g. described in U.S. Pat. Nos. 3,286,992 and 3,664,638. They are commercially available from different producers, e.g. from StaMixCo Technology AG and JLS International. The static mixing elements may have means for heating and cooling.

Preferably, the tubular reactor comprises several static mixers which are arranged in series, i.e. the reactor comprises a series of tubes having static mixing element located in the interior of the tube. For instance, 2, 3, 4, 5, 6, 7 or 8 or more identical or different static mixers are arranged in series to form the reactor. In a series of static mixers, adjacent static mixers may be connected directly to each other, e.g. by short pipe sections or fittings, respectively, or by adapters. For example, the reactor comprises a series of static mixers arranged as a stack connected by curved fittings. For practical reasons, the reactor comprises a series of directly connected static mixers, which are arranged vertically.

In particular, the tubular reactor comprises at least two, e.g. 2, 3, 4, 5, 6, 7 or 8 or more reaction zones arranged in series, more particularly at least two, e.g. 2, 3, 4, 5, 6, 7 or 8 or more identical or different static mixers combined in series, which are operated at different temperatures. In particular, the reaction zone of the tubular reactor, e.g. the static mixer, adjacent to the feeding point is operated at a lower temperature than the reaction zone adjacent to the discharge point. In particular, the reaction zone of the tubular reactor adjacent to the feeding point is operated at a temperature which is at least 10 K, e.g. 10 to 100 K lower than the temperature of the reaction zone adjacent to the discharge point. For example, the reaction zone of the tubular reactor adjacent to the feeding point is operated at a temperature in the range of 60 to 130° C., while the reaction zone adjacent to the discharge point is operated at a temperature in the range of 90 to 200° C. or 90 to 180° C.

Preferably, the reactor is operated with a laminar flow pattern or flow regime rather than a turbulent flow regime. The term “flow regime” refers to the kind of flow of the fluid inside the tubular reactor. The flow regime is decided by a dimensionless number, called the Reynolds number (Re). The Reynolds number is the ratio of inertial resistance to viscous resistance for a flowing fluid which for tubular flow is defined by the following formula:

Re=

where Re is Reynolds number, p is the density of the fluid, v is the flow velocity of the reactants, typically the average flow velocity over the cross section of the tube, d is the internal diameter of the tube, and q is the dynamic viscosity of the liquid reactants. For a turbulent flow the Re value is typically >1000, while for a flow regime with predominant laminar flow the Re value is typically <200.

So that there is a sufficient flow of reactants inside the tubular reactor, a sufficient pressure difference in the direction of flow should be ensured. Accordingly, the pressure difference or pressure drop between the feeding point and the discharge point of the tubular reactor is typically in the range of 0.05 MPa 10 MPa, in particular in the range of 0.1 MPa to 5 MPa and more preferably in the range of 0.2 MPa to 4 MPa.

Said pressure drop can be measured using any suitable technique known to the person skilled in the art. For instance, it is measured as the difference of the pressure determined at the inlet of the first static mixer and the outlet of the last static mixer. The skilled person can easily determine the configuration and set up of the static mixer, e.g. length and diameter of the mixing elements, to achieve the desired pressure drop. The absolute pressure in the tubular reactor is typically in the range of 1.1 to 100 MPa, in particular in the range of 1.2 to 40 MPa. Accordingly, the overpressure in the tubular reactor is typically in the range of 0.1 to 99 MPa, in particular in the range of 0.2 to 39 MPa. Higher pressures are not detrimental to the reaction.

The components fed into the reactor typically do not comprise a chain extender. However, it is possible to use chain extenders at a late stage of the process in order to increase the molecular weight. Suitable chain extenders are described below in the context of the optional step iv. The chain extender is preferably fed into the reactor only near the end of the reaction, preferably at a point in the reactor, where the reaction mixture has already spent at least 50%, in particular at least 70% of its total residence time in the reactor. Preferably, no chain extender is fed into the reactor during step ii.

Preferably, step ii. is carried out at least initially in the absence of an organic solvent having no hydrogen active groups. Therefore, the amount of organic solvent, i.e. organic compounds which do not have any active hydrogen functional group and a molecular weight of at most 200 g/mol in the reactants fed to the reactor is preferably less than 1% by weight, based on the total weight of reactants fed to the reactor, in particular less than 0.1% by weight or zero.

Preferably, the dynamic viscosity at the reaction temperature of the polyurethane produced in step ii. does not exceed 103 Pa·s and is preferably not higher than 500 Pa·s, e.g. in the range of 1000 Pa·s, in particular in the range of 2 to 700 Pa·s and especially in the range of 5 to 500 Pa·s, before it is emulsified. The dynamic viscosity of the molten polyurethane will depend on its average molecular weight, and its degree of branching both of which can be adjusted by the presence of chain extenders present in the components fed into the reactor. The values of dynamic viscosity given here refer to the values measured at 80° C. using a Brookfield CAP 2000+ rheometer with spindle 5 and 20, 10 or 5 rpm, respectively.

For emulsification, it might be helpful if the viscosity of the polyurethane obtained at the end of step ii. does not exceed 50 Pa·s as measured at the temperature in the feed-line between reactor and the apparatus wherein the carboxylated polyurethane is dispersed in water. Therefore, it might be helpful, if a small amount of plasticizing agent is fed to the reaction mixture at the end of the reaction, i.e. shortly before the polyurethane is discharged from the reactor in order to reduce the viscosity discharged from the reactor to a value of at most 50 Pa·s as measured at the temperature in the feed-line. Suitable plasticizing solvents are organic solvents having no active hydrogen groups.

Preferably, the plasticizing agents are water-miscible at a temperature in the range of 20 to 100° C. They include, but are not limited to, ketones having 3 to 8 carbon atoms, in particular aliphatic or cycloaliphatic ketones having 3 to 8 carbon atoms, such as acetone, methylethyl ketone, cyclohexanone and isobutylmethyl ketone, and di-Cr-Ce-alkyl ethers of mono-, di- or trialkylene glycols, such as diethyleneglycol dimethyl ether, triethyleneglycol dimethyl ether, dipropyleneglycol dimethyl ether, tripropyleneglycol dimethyl ether. Preferably, the amount of plasticizing agent does not exceed 20% by weight, based on the total weight of polyurethane formed in step ii. If required, the amount of plasticizing solvent is in the range of 1 to 20% by weight, in particular 2 to 15% by weight, based on the total weight of polyurethane formed in step ii.

Depending on the molar ratio of NCO groups to isocyanate reactive groups in the compounds fed to the reactor, the obtained polyurethane may still have reactive NCO groups at its termini. Any remaining terminal groups will be active hydrogen groups, such as OH groups. The content of NCO groups in the polyurethane may vary and is generally in the range of 0 to 6 wt.-%, in particular in the range of 0 to 3 wt.-%, based on the total weight of the polyurethane. If present, the content of NCO groups in the polyurethane is generally in the range of 0.1 to 6 wt.-% or 0.2 to 4 wt.-%, in particular in the range of 0.5 to 3 wt.-%, based on the total weight of the polyurethane. However, the content of NCO groups in the polyurethane may also be less than 0.1 wt.-%, based on the total weight of the polyurethane, or below the detection limit.

The number average molecular weight of the polyurethane discharged from the reactor will generally be in the range of 500 to 100000 Dalton, determined by gel permeation chromatography as described above.

In step iii., the polyurethane prepared in step ii. is discharged from the reactor and dispersed in water to obtain the polyurethane dispersion. Dispersion of the polyurethane in water can be carried out by analogy to the known processes described for continuous emulsification of polyurethanes or polyurethane prepolymers in water, which have been described e.g. in WO 98/41552, WO 20217/009161, WO 2019/117721 or WO 2020/111944.

Generally, the polyurethane is discharged as a melt from the reactor. In order to disperse the polyurethane in water, the melt is continuously mixed with water, and the thus obtained mixture is homogenized. Mixing with water and homogenization can be carried out subsequently or concomitantly. Here and in the following, the terms “dispersing the polyurethane”, “emulsifying the polyurethane” and “emulsification of the polyurethane” are used synonymously and refer to the provision of a dispersion of the polyurethane produced in step ii.

Suitable devices for dispersing the polyurethane in water include, but are not limited to, dynamic mixers, in particular dynamic high shear mixers including centrifugal mixers or rotor stator mixers, and also static mixers as described above, in particular X-mixers, rooftop disc mixers or helical mixers. Particular preference is given to X-mixers and rotor-stator mixers.

Rotor-stator mixers are familiar to the person skilled in the art and in principle comprise all of the types of dynamic mixers, where a high-speed, preferably rotationally symmetrical, rotor interacts with a stator to form one or more operating regions which, in essence, have the shape of an annular gap. Within said operating regions, the material to be mixed is subjected to severe shear stresses, and high levels of turbulence often prevail in these annular gaps, and likewise promote the mixing process. The rotor-stator apparatus is operated at a relatively high rotational rate, generally from 1000 to 20 000 rpm. This gives high peripheral velocities and a high shear rate, thus subjecting the emulsion to severe shear stresses, which lead to effective comminution of the melt and, thus, to very effective emulsification. Among the rotor-stator mixers are, by way of example, toothed-ring dispersers, annular-gap mills, and colloid mills. Rotor-stator mixers are known to the person skilled in the art by way of example from DE 10024813 A1 and US 2002/076639, and are supplied by way of example by Cavitron Verfahrenstechnik v. Hagen & Funke GmbH, Sprockhövel, Germany.

The amount of water used in step iii. for dispersing the carboxylated polyurethane may vary and is typically chosen, such that a concentration of the carboxylated polyurethane in the dispersion will be in the range of 10 to 65% by weight, in particular in the range of 20 to 55% by weight or in the range of 25 to 50% by weight, based on the total weight of the dispersion.

Generally, dispersing the carboxylated polyurethane discharged from the reactor is carried out at a temperature in the range of 50 to 200° C., in particular in the range of 60 to 160° C. The time required for emulsification will typically be in the range of 0.01 to 600 s, in particular in the range of 0.1 to 300 s. For example, in a static mixer the residence time will typically be longer, e.g. in the range of 5 to 300 s, than in a dynamic mixer, such as a rotor-stator mixer, where residence times typically in the range of 0.01 to 10 s, in particular in the range of 0.1 to 5 s are required to achieve a stable dispersion of the polyurethane. Longer residence times however are not detrimental to the product quality.

While it is principally possible to promote the formation of the dispersion and to stabilize the particles of the polyurethane in the aqueous dispersion by means of one or more emulsifiers, there is no need for emulsifiers, since the carboxyl groups present in the polyurethane will foster the emulsification of the polyurethane and stabilize the polyurethane particles in the aqueous phase of the dispersion. For this, the emulsification of the polyurethane in water is preferably carried out in the presence of the base in order to convert the carboxyl groups present in the polyurethane at least partly into their anionic form.

The base may be present either in a stoichiometric amount or in deficiency in relation to the carboxyl groups present in the polyurethane. Preferably, the base is present in an amount of at least 30 mol-%, in particular at least 50 mol-%, e.g. in an amount of 30 to 120 mol-% or 50 to 110 mol-% based on the carboxyl groups of the polyurethane. Suitable bases include alkali or alkaline earth compounds, such as sodium hydroxide, potassium hydroxide, calcium hydroxide, sodium carbonate; ammonia; primary, secondary and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminethylamine, 2,3-diaminopropane, 1,2-propylenediamine, dimethylaminopropylamine, neopentanediamine, hexamethylenediamine, 4,9-dioxadodecane-1,12-diamine, polyethyleneimine or polyvinylamine.

However, a base is not necessarily required for stabilization of the polyurethane particles in the PUD if, in addition to the carboxyl groups, the polyurethane contains anionic groups or strongly acidic groups, i.e. acidic groups which have a pKa of less than 2 (at 20° C. in water), which will immediately convert into their anionic form when the polyurethane is dispersed in water. Such groups are in particular sulfonate groups. Such sulfonate groups may be introduced via the polymeric polyol compound b), by a suitable further active hydrogen compound c) which bears a sulfonate group or by a suitable chain extender e) described below.

As mentioned above, an emulsifier is not required for the emulsification of the polyurethane and the stabilization of the polyurethane particles. Therefore, in preferred groups of embodiments the emulsification of the polyurethane in step iii. is carried out in virtual or complete absence of an emulsifier. Virtual absence of an emulsifier means that the amount of emulsifier present during step iii. is less than 0.1% by weight, based on the total amount of polyurethane to be dispersed in step iii.

The term “emulsifier” is well understood to a skilled person and includes amphiphilic compounds which reduce surface tension of water and form micelles when mixed with water. Emulsifiers suitable for stabilizing aqueous dispersions carboxylated polyurethanes include any anionic and nonionic emulsifiers and combinations thereof. Typically, emulsifiers suitable for stabilizing aqueous dispersions carboxylated polyurethanes have a HLB (hydrophilic lipophilic balance) value according to Griffin in the range of 8 to 20. For HLB value see e.g. W. C. Griffin, J. Soc. Cosmet. Chem. 1, 311 (1950) and 5, 249 (1954). Examples of familiar nonionic emulsifiers are C₂-C₃-alkoxylated, in particular ethoxylated, mono-, di-, and trialkylphenols (degree of ethoxylation from 3 to 50, alkyl radical: C₄ to C₁₂), and also C₂-C₃-alkoxylated, in particular ethoxylated, fatty alcohols (degree of ethoxylation from 3 to 80; alkyl radical: C₈ to C₃₆). Examples of these are the Lutensol® A grades (C₁₂ to C₁₄ fatty alcohol ethoxylates, degree of ethoxylation from 3 to 8), Lutensol® AO grades (C₁₃ to C₁₅ oxo alcohol ethoxylates, degree of ethoxylation from 3 to 30), Lutensol® AT grades (C₁₆ to C₁₈ fatty alcohol ethoxylates, degree of ethoxylation from 11 to 80), Lutensol® ON grades (C10 oxo alcohol ethoxylates, degree of ethoxylation from 3 to 11), and the Lutensol® TO grades (C₁₃ oxo alcohol ethoxylates, degree of ethoxylation from 3 to 20), from BASF SE. Conventional anionic emulsifiers are the salts of amphiphilic substances which have an anionic functional group, such as a sulfonate, phosphonate, sulfate, or phosphate group. Examples of these are the salts, in particular the alkali metal salts and ammonium salts, of alkyl sulfates (alkyl radical: C₈ to C₁₂), the salts, in particular the alkali metal salts and ammonium salts, of amphiphilic compounds which have a sulfated or phosphated oligo-C₂-C₃-alkylene oxide group, in particular a sulfated or phosphated oligoethylene oxide group, examples being the salts, in particular the alkali metal salts and ammonium salts, of sulfuric acid hemiesters of ethoxylated alkanols (degree of ethoxylation from 2 to 50, in particular from 4 to 30, alkyl radical: C₁₀ to C₃₀, in particular C₁₂ to C₁₈), the salts, in particular the alkali metal salts and ammonium salts, of sulfuric acid hemiesters of ethoxylated alkylphenols (degree of ethoxylation from 2 to 50, alkyl radical: C₄ to C₁₂), the salts, in particular the alkali metal salts and ammonium salts, of phosphoric acid hemiesters of ethoxylated alkanols (degree of ethoxylation from 2 to 50, in particular from 4 to 30, alkyl radical: C₁₀ to C₃₀, in particular C₁₂ to C₁₈), the salts, in particular the alkali metal salts and ammonium salts, of phosphoric acid hemiesters of ethoxylated alkylphenols (degree of ethoxylation from 2 to 50, alkyl radical: C₄ to C₁₂), the salts, in particular the alkali metal salts and ammonium salts, of alkylsulfonic acids (alkyl radical: C₁₂ to C₁₈), the salts, in particular the alkali metal salts and ammonium salts, of alkylarylsulfonic acids (alkyl radical: C₉ to C₁₈), and also the salts, in particular the alkali metal salts and ammonium salts, of alkylbiphenyl ether sulfonic acids (alkyl radical: C₆ to C₁₈), an example being the product marketed as Dowfax® 2A1.

The process of the invention may further comprise a chain extension or crosslinking step iv. Step iv. may be carried out during step iii. or after step iii.

For carrying out step iv., a polyurethane will be produced in step ii. which still have reactive NCO groups, which is capable of undergoing a reaction with a suitable crosslinking or chain extending compound thereby forming covalent bonds between the polyurethane and the skeleton of the crosslinking or chain extending compound, which are hereinafter briefly termed crosslinker or chain extender and referred to as compound e) or component e), respectively. For efficient chain extension/crosslinking, the content of NCO groups in such a polyurethane is generally at least 0.2 wt.-%, in particular at least 0.5 wt.-%, e.g. in the range of 0.2 to 6 wt.-%, in particular in the range of 0.5 to 3 wt.-%, based on the total weight of the polyurethane.

Suitable crosslinker or chain extender compounds e) or component e) are principally any organic compounds having on average at least 2, e.g. 2 to 6 isocyanate reactive groups, in particular primary amino groups, secondary amino groups or hydroxyl groups. It should be noted that a primary amino group may count for 2 isocyanate reactive groups because it may react with two isocyanate groups.

Components e) include, but are not limited to
organic di- or polyamines for example ethylene-1,2-diamine, 1,2- and 1,3-diaminopropane, 1,4-diaminobutane, 1,6-diaminohexane, isophoronediamine, isomer mixture of 2,2,4- and 2,4,4-trimethylhexamethylene-diamine, 2-methylpentamethylenediamine, diethylenetriamine, 4,4-diamino-dicyclohexylmethane, hydrazine hydrate and/or dimethylethylene-diamine;
compounds which have at least two groups selected from primary amino groups, secondary amino groups and OH groups, such as 3-amino-1-methylamino-propane, 3-amino-1-ethylaminopropane, 3-amino-1-cyclohexylaminopropane, 3-amino-1-methylaminobutane, alkanolamines such as diethanolamine, N-aminoethylethanolamine, ethanolamine, 3-aminopropanol, neopentanolamine or piperidine;
monofunctional amine compounds, for example methylamine, ethylamine, propylamine, butylamine, octylamine, laurylamine, stearylamine, isononyloxypropylamine, diethyl(methyl)aminopropylamine, N,N-dimethylaminopropylamine;
dihydrazides, for example adipic dihydrazide, oxalic dihydrazide, carbohydrazide and succinic dihydrazide;
long-chain amino-functional compounds such as polyetheramines (“Jeffamines”);
amines containing a sulphonic acid or sulphonate group, more preferably a sodium sulphonate group, in particular the alkali metal salts of the mono- and diaminosulphonic acids. Examples for this are salts of 2-(2-aminoethyl-amino)ethanesulphonic acid, of 3-(2-aminoethylamino)propane sulphonic acid, of 4-(2-aminoethylamino)butane sulphonic acid, of 2-(2-aminopropylamino)ethane sulphonic acid, of 2-(3-aminopropylamino)ethane sulphonic acid, or taurine. In addition, it is possible to use the salt of cyclohexylaminopropanesulphonic acid (CAPS) from WO-A 01/88006;
diamines containing carboxylate groups, i.e. diaminocarboxylic acids and salts thereof, for example sodium N-(2-aminoethyl)-alaninate.

Preference is given to using, as component e), ethylene-1,2-diamine, bis(4-amino-cyclohexyl)-methane, 1,4-diaminobutane, isophoronediamine, ethanolamine, diethanolamine, diethylenetriamine, a salt of 2-(2-aminoethylamino)ethanesulphonic acid or a salt of 3-(2-aminoethylamino)propane sulphonic acid.

The degree of chain extension, i.e. the ratio of equivalents of NCO reactive groups in the compound e) used for chain extension to free NCO groups in the polymer obtained in step ii., is generally between 40% and 150%, preferably between 50% and 110%, more preferably between 60% and 100%. The components e) can optionally be used in water- or solvent-diluted form, individually or in mixtures, in principle with any possible sequence of addition. Said components e) are preferably used in water-diluted form. In the water-diluted form, the concentration of the compound e) is typically in the range of 5 to 60% by weight.

Step iv. is typically carried out at a temperature in the range of 20 to 100° C., in particular in the range of 25 to 80° C. and especially in the range of 30 to 60° C. The reaction time depends on a few parameters, such as reactivity, temperature, dilution and viscosity of the prepolymer or the reaction mixture, and is typically between 1 to 120 min., preferably from 2 to 60 min. and more preferably from 5 to 30 min.

Step iv. can be carried out during step iii. For this, the compound e) is continuously fed together with the polyurethane obtained in step ii. and water into the device used for dispersing the polyurethane. Frequently, step iv. is carried out after having carried out step iii. For this, the compound e) is mixed with the aqueous dispersion of the polyurethane obtained in step iii. In this case, step iv. can be carried out continuously or as a batch. If step iv. is carried out after step iii., it may be carried out in any mixing device, including dynamic mixers, such as stirred tank vessels, or static mixers as described above.

The obtained polyurethane dispersions are stable dispersions of polyurethane particles. The average particle size (Z average) is generally in the range of 10 to 1500 nm, in particular in the range of 30 to 1000 nm.

Determination of the Z average particle size as well as the particle size distribution may also be carried out by quasielastic light scattering (QELS), also known as dynamic light scattering (DLS). The measurement method is described in the ISO 13321:1996 standard. The determination can be carried out using a High-Performance Particle Sizer (HPPS). For this purpose, a sample of the aqueous polymer latex will be diluted, and the dilution will be analyzed. In the context of QELS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The measurement gives an average value of the second order cumulant analysis (mean of fits), i.e., Z average. The “mean of fits” is an average, intensity-weighted hydrodynamic particle diameter in nm.

The solids content of the aqueous polyurethane dispersion will largely depend from the amount of water used in step iii and the optional solvent used for dilution. Generally, the dispersion has a solids content in the range of 10 to 65% by weight, in particular in the range of 20 to 55% by weight or in the range of 25 to 50% by weight, based on the total weight of the dispersion.

Generally, the pH of the obtained aqueous polyurethane dispersion is in the range of 7 to 9, preferably 7.2 to 8.5, as determined at 20° C.

Frequently, the aqueous polyurethane dispersion has a Brookfield viscosity in the range of 5 to 10000 mPa·s, as determined at a temperature of 23° C. and a shear rate of 150 s⁻¹.

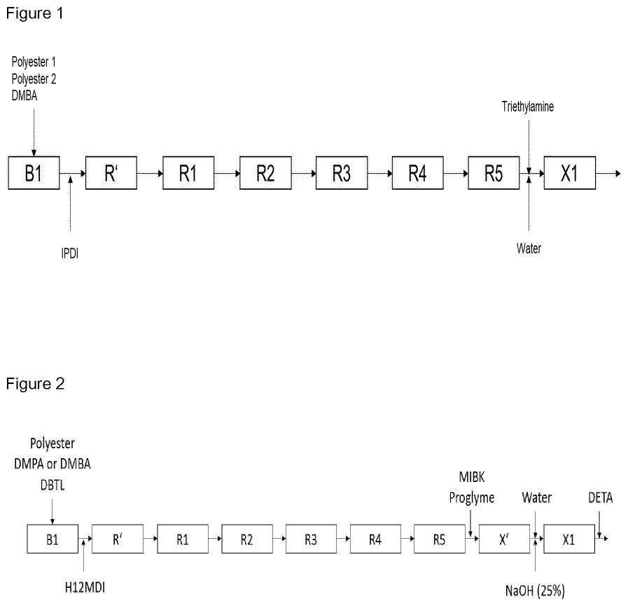

FIG. 1: Schematic drawing of an embodiment of the process of the invention, where the process is carried out in an apparatus comprising a feed vessel (B1), a first mixer R′, a series of 5 mixers (R1)-(R5), a mixer (X1) for emulsification.

FIG. 2: Schematic drawing of an embodiment of the process of the invention, where the process is carried out in an apparatus comprising a feed vessel (B1), a first mixer R′, a series of 5 mixers (R1)-(R5), a mixer (X1) for emulsification, further comprising a mixer (X2) for subsequent chain extension.

FIG. 1 is a schematic drawing of a particular embodiment of the invention, which can be used for producing the PUD of examples 1, 2a and 2b. The apparatus used for carrying out the process comprises a feed vessel (B1) for providing the solution of the aliphatic diol compound a) in the polyol compound b)—here exemplary polyester 1, polyester 2 and 2,2-bis(hydroxymethyl)butyric acid (DMBA). For example, the feed vessel (B1) is a stirred tank reactor with a heating mantle, i.e. a double walled vessel equipped with a stirrer. The apparatus further comprises a first mixer (R′), whose outlet is connected to a series of mixers (R1)-(R5) which can be heated. The mixer (R′) and the mixers (R1)-(R5) are connected to each others via tube sections (fittings), adapters or directly. The mixers (R1)-(R5) are usually static mixers, but may also be dynamic mixers or combinations thereof. The apparatus further comprises a mixer (X1) connected to the outlet of the mixer (R5) for emulsification. The apparatus further comprises metering pumps (not shown) for feeding the solution of the aliphatic diol compound a) in the polyol compound b) and for feeding the isocyanate compound d)—here exemplary isophorone diisocyanate (IPDI)—into the mixer (R′). The apparatus further comprises heat exchangers for controlling the temperature of the mixers (R1)-(R5) and optionally heating elements for heating the conduct lines (not shown).

In the vessel (B1) a solution of the aliphatic diol compound a) in the polyol compound b) and optionally the compound c) is provided by heating the components a), b) and optionally c) until a clear solution is obtained. The mixture in vessel (B1) is optionally agitated or stirred to foster the mutual dissolution of the compounds. By means of a first metering pump (not shown), a first stream of the solution in vessel (B1) is fed into the mixer (R′). In parallel, a second metering pump (not shown) feeds a stream of the isocyanate compound d) (here exemplary IPDI) into the mixer (R′), where the components are continuously mixed to produce a mixed stream of the compounds a)-d). The mixer (R′) is usually a static mixer, but may also be a dynamic mixer. The mixed stream is directly introduced into the first mixer (R1) of the series of mixers (R1)-(R5). The polyurethane formed in the series of mixers (R1)-(R5) is discharged as a melt from the mixer (R5), and the melt is immediately fed together with a stream of the base—here exemplary triethylamine—and stream of water into the mixer (X1), where the melt is emulsified to obtain the PUD, which is discharged from the mixer (X1) fed into a storage vessel. Stream of water may further contain a compound e) to effect chain extension/crosslinking of the polyurethane. The mixer (X1) may be a dynamic mixer, e.g. a rotor-stator mixer, or a static mixer, e.g. an X-mixer.

FIG. 2 is a schematic drawing of a particular embodiment of the invention, which can be used for producing the PUD of examples 3a, 3b and 3c. In addition to the feed vessel (B1), the mixer (R′), the mixers (R1)-(R5) and the mixer (X1), the apparatus for carrying out the reaction comprises a further mixer (X′) located in downstream of the mixer (R5) and upstream of the mixer (X1). The process for the production of the PUD is carried out as described in FIG. 1 with the following difference. A plasticizing solvent—here exemplary a mixture of methylisobutylketone (MBIK) and dipropylene glycol dimethylether (Proglyme)—is fed as stream into mixer X′ to reduce the viscosity of the polyurethane before it is emulsified in the mixer (X1). For emulsification, a stream of water and a stream of base—here exemplary aqueous sodium hydroxide (NaOH 25%)—is fed into mixer X1. Downstream of mixer (X1) a stream of a chain extension agent—here exemplary diethylenetriamine (DETA)—is mixed with the emulsion discharged from mixer X1. For example, a mixture of a polyester and 2,2-dimethylolbutric acid (DMPA) and/or 2,2′-dimethylolpropionic acid (DMPA) containing a catalyst—here dibutlytin dilaurate (DBTL)—can be used as a polymeric polyol compound b) and the aliphatic diol compound a). For example, 4,4′-diisocyanatodicyclohexylmethane (H12MDI) can be used as the isocyanate compound d).

### EXAMPLES

### I. Abbreviations

AN Acid number
DBTL: Dibutyltin dilaurate (CAS: 77-58-7)
DETA: Diethylenetriamine (CAS: 111-40-0)
DMBA: 2,2-Bis(hydroxymethyl)butyric acid (CAS: 10097-02-6)
DMPA: 2,2-bis(hydroxymethyl)propionic acid (CAS: 4767-03-7)
H12MDI: 4,4′-Diisocyanatodicyclohexylmethane (CAS: 5124-30-1)
IPDI: Isophorone diisocyanate (CAS: 4098-71-9)
MDI: Methylendiphenylisocyanate (CAS: 26447-40-5)
MIBK: Methylisobutyl ketone (CAS: 108-10-1)
min.: minutes
OHN hydroxyl number
PUD: aqueous polyurethane dispersion
poly-THF1000: polytetrahydrofurane having a number average molecular weight of 1000 g/mol

### II. Analytics

Viscosity of the polyurethane melt: Brookfield CAP 2000+ rheometer with spindle 5 and 20, 10 or 5 rpm, respectively. The measurements were conducted at 50 to 140° C.

NCO content of the polyurethane melt: The NCO content is determined via n-dibutylamine back titration according to DIN EN ISO 11909:2007.

Viscosity of the PUD: Viscosity was measured at 20° C. according to the standard method DIN EN ISO 3219:1994 using a “Brookfield RV”-type laboratory viscosimeter employing spindles #4 or #5 at 100 revolutions per minute.

Solids content of PUD: The solids content was determined by drying a defined amount of PUD (about 2 g) to constant weight in an aluminum crucible having an internal diameter of about 5 cm at 130° C. in a drying cabinet (2 hours). Two separate measurements were conducted. The value reported in the example is the mean of the two measurements.

Particle size of the PUD: The average particle diameter of the PUD was determined by dynamic light scattering (DLS) as described above, using a Malvern HPPS.

pH of the PUD: pH values of the PUDs were measured at ambient conditions utilizing a Portamess 913 pH-meter (from Knick Elektronische Messgerste GmbH & Co. KG) equipped with a glass electrode from SI Analytics. The device is calibrated on regular terms with two buffer solutions (pH 7.00/pH 9.21)

The acid numbers of polyurethanes can be determined by potentiometric titration with ethanolic potassium hydroxide according to the following procedure: About 1 g of the polyurethane is dissolved in a mixture of 10 mL toluene and 10 mL pyridine. A cooler is added and the mixture is heated under stirring at 50° C. for roughly 1 h. After the addition of 5 mL deionized water the mixture is cooled to room temperature and 50 mL tetrahydrofuran are added through the cooler. The solution is potentiometrically titrated with an ethanolic potassium hydroxide standard solution of known concentration. The blind value is determined at the same procedure but without the polymer.

### III. Working Examples

### Test Examples

Tests examples 1 to 4 (not according to the invention). The test examples were carried out to assess whether previous dissolution of dimethylol propionic acid (DMPA) in the polyol (2 step) improves incorporation of DMPA into the polyurethane resin compared to a procedure where a mixture of DMPA with polyol and poly isocyanate is reacted to form the polyurethane resin (all-in).

### Test Example 1 (All-In)

475.62 g of polycaprolactone (OHN=112 mgKOH/g), 31.9 g dimethylol propionic acid and 80.0 g hexamethylene diisocyanate were charged to a glass reactor equipped with a stirrer. The mixture was heated with stirring to 85° C. and due to an exotherm the temperature raised to 99° C. within 10 min. During further 2 hours the temperature was held between 100-105° C. and full conversion was observed.

### Test Example 2 (Two Step)

475.62 g of polycaprolactone (OHN=112 mgKOH/g) and 31.9 g dimethylol propionic acid were charged to a glass reactor equipped with a stirrer and heated with stirring to 120° C. until the mixture appeared as clear, homogeneous melt (appr. 2-3 h). Then, 80.0 g hexamethylene diisocyanate were add added dropwise with stirring during 10 minutes and the temperature was maintained at 125° C. until full conversion was observed.

### Test Example 3 (All-In)

590.3 g of poly-THF1000 (OHN=113 mgKOH/g), 39.9 g of dimethylol propionic acid and 100.0 g hexamethylene diisocyanate were charged to a glass reactor equipped with a stirrer. The mixture was heated with stirring to 85° C. and due to an exotherm the temperature raised to 99° C. within 10 min. During further 2 hours the temperature was between 100-105° C. and full conversion was observed.

### Test Example 4 (2 Step)

500 g of poly-THF1000 (OHN=113 mgKOH/g) and 33.8 g of dimethylol propionic acid were heated to 120° C. until the mixture appeared as clear, homogeneous melt (appr. 2-3 h). 84.7 g hexamethylene diisocyanate was added dropwise during 10 minutes and the temperature was maintained at 125° C. until full conversion was observed.

The polyurethanes of test examples 1 to 4 where analyzed with regard to the residual DMPA content by means of HPLC. Thereby the in total incorporated DMPA could be determined. Apart from that the effect acid number was determined. The results are summarized in the following table A.

The polyurethanes of test examples 1 to 4 were also emulsified in a 2% by weight aqueous solution of diethanolamine to a total concentration of about 30% by weight by means of a) a high-shear mixer (Juchheim reactor with dispersion disc, at 120° C. rpm=2000, start stirring at 50° C. and increase rpm and T to final values) or b) dissolved in acetone after solvent-free polymer synthesis. For a), the molten polyurethane and the aqueous solution of diethanolamine were loaded into the reactor and heated to 50° C. Then, the speed of the dispersing disc was set to 2000 rpm step-wise while the temperature was increased to 120° C. After 20 minutes at 120° C. and 2000 rpms the temperature was decreased to room temperature and the particle size of the thus obtained emulsion was determined and is given in the following table A. For b), the molten polyurethane was dissolved in acetone to approx. 40% by weight and mixed with diethanolamine and water subsequently in a glass reactor at approx. 200 rpm. After removing acetone at reduced pressure the particle size of the thus obtained emulsion was determined and is given in the following table A.

TABLE A

| | | AN eff ¹⁾ | Incorporation of | PSD |
|---|---|---|---|---|
| Test example | | (mg KOH/g) | DMPA | [nm] |
| 1 | all-in | 9.2 | 39% | 33000 |
| 2 | 2-step | 17.9 | 69% | 375 |
| 3 | all-in | 7.1 | 30% | 58600 |
| 4 | 2-step | 13.1 | 56% | 164 |

¹⁾ Acid Number, determined

The “all-in” procedure led always to polyurethane resins with less than 50% of incorporated DMPA into the polymer chain. A relatively high DMPA amount did not react and could therefore not contribute to the particle stabilization. By changing to a 2-step procedure, i.e. fully dissolving the DMPA in the respective polyol or polyol mixture prior to the isocyanate addition and reaction start, stable, sub-pm particle containing polyurethane dispersions were obtained. The improvement was further confirmed by lower DMPA residual contents and thus higher effective acid numbers.

### Example 1

The Following Starting Materials were Used:

Polyester 1: Polyester made of hexanediol, isophthalic acid and dimeric fatty acid having an OH number of 73 mg KOH/g and a number average molecular weight of about 2000 g/mol measured in THF/acetic acid (0.1%) using polystyrene as standard. Polyester 2: Polyester made of hexanediol, neopentyl glycol, adipic acid and isophthalic acid having an OH number of 51 mg KOH/g and a number average molecular weight of about 1700 g/mol measured in TH F/acetic acid (0.1%) using polystyrene as standard.
Isophorone diisocyanate, reagent grade
2,2-Bis(hydroxymethyl)butyric acid, reagent grade
Triethylamine, reagent grade
Deionized Water

The example was carried out in the reaction equipment shown in FIG. 1 and described in detail below.

A double-walled glass stirred tank reactor (B1) with a volume of 6 L equipped with a cross-blade stirrer was employed for dissolving DMBA in the polyesters P1 and P2 and served a feed vessel for the continuous process.

The reaction equipment comprises a first static mixer (R′) for mixing the components and a reactor comprising a series of five mixers (R1)-(R5) for carrying out the reaction and mixer module (X1) for carrying out the emulsification. The mixers (R1)-(R5) were double-wall tubes having different volumes which had in their interior static mixing elements. The mixers (R1)-(R5) were arranged horizontally as a stack and were connected to each other by curved tubes. The temperatures of the mixers (R1)-(R5) were regulated via five thermostats (not shown) of the type HE4 from Julabo, USA. The static mixer (R′) was integrated vertically into the feed conduit and was located upstream of the horizontal mixer (R1). The mixers (R1)-(R5) and the mixer (R′) were Fluitec CSE-X® static mixers sourced from Fluitec International, USA. The properties of the individual mixers are provided in Table 1.

TABLE 1

| Properties | R′ | R1 | R2 | R3 | R4 | R5 |
|---|---|---|---|---|---|---|
| Diameter (in mm) | 8.0 | 12.3 | 21.0 | 12.3 | 21.0 | 21.0 |
| Volume (in ml) | 8 | 45 | 130 | 45 | 130 | 130 |
| Temperature | 90 | 90 | 90 | 110 | 120 | 120 |
| (max.) in ° C. | | | | | | |
| Mixer type | CSE- X/6 | CSE- X/8 | CSE- X/4 | CSE- X/8 | CSE- X/4 | CSE- X/4 |

A high-shear mixer (X1) (Cavitron CD1000, manufactured by Cavitron of Hagen & Funke GmbH) was employed for the emulsification process. The inlet of the apparatus is connected to the outlet of the mixer (R5). Water and base were fed into the inlet of X1 by metering pumps.

2008 g of polyester 1, 2008 g of polyester 2 and 483 g of DMBA were introduced into (B1). The heating mantle of (B1) was set to a temperature 145° C. The mixture was stirred until a clear solution is obtained (about 60 minutes) and then kept at 145° C.

The feed conduits, the mixer R′, the reactors (R1)-(R5) and the discharge facility were preheated for at least 1 hour before starting the process. The feed conduits for IPDI were partly co-heated. This brings about slight preheating of IPDI before it was mixed in (R′) with the solution from (B1).

First, the solution of DMBA in the polyesters P1 and P2 was fed from (B1) into the mixer (R′) by means of a first metering pump (not shown). 15 minutes after the start of this feed, IPDI was fed into mixer (R′) by means of a second metering pump (not shown) to obtain a mixed stream of DMBA, polyesters P1 and P2 and IPDI. The residence time in the mixer (R′) was 15 min. The mixed stream from (R′) was then introduced into series of five mixers (R1)-(R5). The polyurethane from the outlet of the mixer (R5) was emulsified in the mixer (X1). For this, water and triethylamine were fed by metering pumps into the inlet of the apparatus. The rotation speed of the high-shear mixer (X1) was between 10.000 and 18.000 1/s resulting in a circumferential speed of 26-47 m/s.

The relative amounts of the compounds used for the preparation of the polyurethane polymer are given in table 2. The reaction conditions are summarized in the following table 3.

A sample of the polyurethane taken from the outlet of (R5) showed a dynamic viscosity of 272 Pa·s at a temperature of 80° C. The obtained PUD was characterized by a particle size (Z-average) of 142 nm, a solids content of 32% and a pH of 7.0.

TABLE 2

| Compound | Amount (wt.-%) |
|---|---|
| Polyester1 | 11.4 |
| Polyester 2 | 11.4 |
| DMBA | 2.7 |
| IPDI | 5.5 |
| Triethylamine | 1.4 |
| Water | 67.5 |

TABLE 3
Example 1

| | | | |
|---|---|---|---|
| Mixer R′ | Mass flow (in g/h) | Polyester 1/ | 1652 |
| | | Polyester 2/DMBA | |
| | | IPDI | 358 |
| | Temperature (in ° C.) | R′ | 80 |
| Mixers R1-R5 | Temperature (in ° C.) | R1 | 90 |
| | | R2 | 105 |
| | | R3 | 130 |
| | | R4 | 155 |
| | | R5 | 160 |
| | Pressure (in bar) | Before R′ | 7.2 |
| | | After R5 | 0.6 |
| Mixer X1 | Mass flow (in g/h) | Water | 4356 |
| | | Triethylamine | 91.9 |

### Example 2a

The following starting materials were used:

Polyether polyol: Commercial EO/PO/EO triblock copolymer having a number average weight of 1750 g/mol containing a central PO block and containing +10 wt.-% of EO units (Pluronic PE 6100).
MIDI, reagent grade
2,2-Bis(hydroxymethyl)butyric acid, reagent grade
NaOH, 25 wt.-% aqueous solution of sodium hydroxide
Deionized Water

The example was carried out in the reaction equipment described for example 1. 2808 g of polyether polyol and 213 g of DMBA were introduced into (B1). The heating mantle of (B1) was set to a temperature 145° C. The mixture was stirred until a clear solution is obtained (about 60 minutes) and then kept at 145° C.

The feed conduits, the mixer R′, the reactors (R1)-(R5) and the discharge facility were preheated for at least 1 hour before starting the process. The feed conduits for MDI were partly co-heated. This brings about slight preheating of MDI before it was mixed in (R′) with the solution from (B1).

First, the solution of DMBA in the polyether polyol was fed from (B1) into the mixer (R′) by means of a first metering pump (not shown). 15 minutes after the start of this feed, MDI was fed into mixer (R′) by means of a second metering pump (not shown) to obtain a mixed stream of DMBA, polyetherpolyol and MDI. The residence time in the mixer (R′) was 15 min. The mixed stream from (R′) was then introduced into series of five mixers (R1)-(R5). The polyurethane from the outlet of the mixer (R5) was emulsified in the mixer (X1). For this, water and a 25% aqueous solution of sodium hydroxide were fed by metering pumps into the inlet of the apparatus. The rotation speed of the high-shear mixer (X1) was between 10.000 and 18.000 1/s resulting in a circumferential speed of 26-47 m/s.

The relative amounts of the compounds used for the preparation of the polyurethane polymer are given in table 4. The reaction conditions are summarized in the following table 5.

A sample of the polyurethane taken from the outlet of (R5) showed a dynamic viscosity of 33.8 Pa·s at a temperature of 80° C. The obtained PUD was characterized by a particle size (Z-average) of 32 nm, a solids content of 30% and a pH of 8.0.

TABLE 4

| Compound | Amount (wt.-%) |
|---|---|
| Polyether polyol | 22.4 |
| DMBA | 1.7 |
| MDI | 5.4 |
| NaOH (25% in water) | 1.7 |
| Water | 68.8 |

TABLE 5
Example 2a

| | | | |
|---|---|---|---|
| Mixer R′ | Mass flow (in g/h) | Polyol/DMBA | 1644 |
| | | MDI | 366.4 |
| | Temperature (in ° C.) | R′ | 80 |
| Mixers R1-R5 | Temperature (in ° C.) | R1 | 90 |
| | | R2 | 105 |
| | | R3 | 130 |
| | | R4 | 155 |
| | | R5 | 160 |
| | Pressure (in bar) | Before R′ | 1.4 |
| | | After R5 | 0.4 |
| Mixer X1 | Mass flow (in g/h) | Water | 4700 |
| | | 25 wt.-% aqueous | 118.9 |
| | | NaOH | |

### Example 2b

The example 2b was carried out by the protocol of example 2a, except for the following. Instead of the high-shear mixer Cavitron CD1000 a static mixer, namely Fluitec CSE-X/8 (Internal diameter 12.3 mm, internal volume=45 ml) was employed for the emulsification process.

A sample of the polyurethane taken from the outlet of (R5) showed a dynamic viscosity of 33.8 Pa·s at a temperature of 80° C. The obtained PUD was characterized by a particle size (Z-average) of 40 nm, a solids content of 30.6% and a pH of 7.8.

### Example 3a

The following starting materials were used:

Polyester: Polyester made of hexanediol, isophthalic acid and dimeric fatty acid having an OH number of 73 mg KOH/g and a number average molecular weight of about 2000 g/mol measured in THE/acetic acid (0,1%) using polystyrene as standard.
H12MDI, reagent grade
2,2-Bis(hydroxymethyl)butyric acid, reagent grade
2,2-Bis(hydroxymethyl)propionic acid, reagent grade
Dibutyltin dilaurate, reagent grade
Methyl isobutyl ketone, reagent grade
Dipropyleneglycol dimethylether (Proglyme), reagent grade
Diethylendetriamine, reagent grade
Deionized Water

The example was carried out in the reaction equipment shown in FIG. 2 and described in detail below.

A double-walled glass stirred tank reactor (B1) with a volume of 6 L equipped with a cross-blade stirrer was employed for dissolving DMBA in the polyesters P1 and P2 and served a feed vessel for the continuous process.

The reaction equipment comprises a first static mixer (R′) for mixing the components and a reactor comprising a series of five mixers (R1)-(R5) for carrying out the reaction and mixer module (X1) for carrying out the emulsification. The mixers (R1) (R5) were double-wall tubes having different volumes which had in their interior static mixing elements. The mixers (R1)-(R5) were arranged horizontally as a stack and were connected to each other by curved tubes. The temperatures of the mixers (R1)-(R5) were regulated via five thermostats (not shown) of the type HE4 from Julabo, USA. The static mixer (R′) was integrated vertically into the feed conduit and was located upstream of the horizontal reactor (R1). The static mixer (X′) was integrated vertically into the conduit between (R5) and (X1) and was located downstream of the mixer (R5) and upstream of the mixer (X1). The mixers (R1)-(R5) and the mixers (X′) and (R′) were Fluitec CSE-X® static mixers sourced from Fluitec International, USA. The properties of the individual mixers are provided in Table 6.

TABLE 6

| Properties | R′ | R1 | R2 | R3 | R4 | R5 | X′ |
|---|---|---|---|---|---|---|---|
| Diameter (mm) | 8.0 | 12.3 | 21.0 | 12.3 | 21.0 | 21.0 | 8 |
| Volume (ml) | 8 | 45 | 130 | 45 | 130 | 130 | 8 |
| Mixer type | CSE-X/6 | CSE-X/8 | CSE-X/4 | CSE-X/8 | CSE-X/4 | CSE-X/4 | CSE-X/6 |

A high-shear mixer (X1) (Cavitron CD1000, manufactured by Cavitron of Hagen & Funke GmbH) was employed for the emulsification process. The inlet of the high-shear mixer (X1) is connected to the outlet of (X′). Water, base and compound e) were fed into the inlet of X1 by metering pumps. 2362 g of Polyester, 127 g of DMBA and 11.5 g of DBTL were introduced into (B1). The heating mantle of (B1) was set to a temperature 145° C. The mixture was stirred until a clear solution is obtained (about 60. minutes) and then kept at 145° C.

The feed conduits, the mixer R′, the reactors (R1)-(R5) and the discharge facility were preheated for at least 1 hour before starting the process. The feed conduits for H12MDI were partly co-heated. This brings about slight preheating of H12MDI before it was mixed in (R′) with the solution from (B1).

First, the solution of DMBA and DBTL in the polyester was fed from (B1) into the mixer (R′) by means of a first metering pump (not shown). 15 minutes after the start of this feed, H12MDI was fed into mixer (R′) by means of a second metering pump (not shown) to obtain a mixed stream of DMBA, DBTL, polyester and H12MDI. The residence time in the mixer (R′) was 15 min. The mixed stream from (R′) was then introduced into series of five mixers (R1)-(R5). The polyurethane from the outlet of the mixer (R5) was diluted with MIBK and Proglyme in mixer (X′) followed by emulsification and chain extension of the diluted mixture in the mixer (X1). For this, water, aqueous solution of NaOH (25 wt.-%) and an aqueous solution of DETA (9 wt.-%) were fed by metering pumps into the inlet of the apparatus (X1). The rotation speed of the high-shear mixer (X1) was between 10.000 and 18.000 1/s resulting in a circumferential speed of 26-47 m/s.

The amount relative amounts of the compounds used for the preparation of the polyurethane polymer are given in table 7. The reaction conditions are summarized in the following table 8.

A sample of the polyurethane taken from the outlet of (R5) showed a dynamic viscosity of 143 Pa·s at a temperature of 80° C. and an NCO content of 2.22%. A sample of the polyurethane taken from the outlet of (X′) (after dilution with MIBK and Proglyme) showed a dynamic viscosity of 27 Pa·s at a temperature of 80° C. The obtained PUD was characterized by a particle size (Z-average) of 264 nm, a solids content of 40% and a pH of 7.5.

### Example 3b

The example 3b was carried out by analogy to the protocol of example 3a, except for the following. 2468 g of Polyester, 120.1 g of 2,2-bis(hydroxymethyl)propionic acid (DMPA) and 12.0 g DBTL were introduced in a stirred tank (B1). The heating mantle temperature was set to 200° C. The mixture was stirred until a clear solution is obtained and then kept at 200° C. to obtain a clear solution which took about 60 min. The following reaction conditions were modified as summarized in table 8. The relative amounts of the compounds used for the preparation of the polyurethane polymer are given in table 7.

A sample of the polyurethane taken from the outlet of (R5) showed a dynamic viscosity of 337 Pa·s at a temperature of 80° C. and an NCO content of 2.24%. The obtained PUD was characterized by a particle size (Z-average) of 1383 nm, a solids content of 40.5% and a pH of 7.8.

### Example 3c

The example 3b was carried out by analogy to the protocol of example 3a, except for the following. 2844 g of Polyester, 48.8 g of 2,2-bis(hydroxymethyl)butyric acid (DMBA), 99.9 g of 2,2-bis(hydroxymethyl)propionic acid (DMPA) and 13.8 g DBTL were introduced in a stirred tank (B1). The heating mantle temperature was set to 130° C. The mixture was stirred until a clear solution is obtained and then kept at 130° C. to obtain a clear solution which took about 60 min. The following reaction conditions were modified as summarized in table 8. The amount relative amounts of the compounds used for the preparation of the polyurethane polymer are given in table 7.

A sample of the polyurethane taken from the outlet of (R5) showed a dynamic viscosity of 181 Pa·s at a temperature of 70° C. and an NCO content of 2.22%. The obtained PUD was characterized by a particle size (Z-average) of 349 nm, a solids content of 40.1% and a pH of 7.7.

TABLE 7

| | 3a | 3b | 3c |
|---|---|---|---|
| Polyester [wt.-%] | 27.2 | 27.2 | 27.2 |
| DMBA [wt.-%] | 1.5 | 0 | 0.4 |
| DMPA [wt.-%] | 0 | 1.3 | 1.0 |
| DBTL [wt.-%] | 0.1 | 0.1 | 0.1 |
| H12MDI [wt.-%] | 10.4 | 10.4 | 10.4 |
| Proglyme [wt.-%] | 2.9 | 2.9 | 2.9 |
| MIBK [wt.-%] | 2.9 | 2.9 | 2.9 |
| NaOH (25% in water) | 1.5 | 1.6 | 1.6 |
| Water [wt.-%] | 48.2 | 47.6 | 48.2 |
| DETA (9% in water) | 5.3 | 5.9 | 5.3 |

TABLE 8
Example 3c

| | | | 3a | 3b | 3c |
|---|---|---|---|---|---|
| Mixer R′ | Mass flow (in g/h) | Polyester/DMBA | 739 | 1476 | 738 |
| | | and/or DMPA/DBTL | | | |
| | | H12MDI | 266 | 533.7 | 266.0 |
| | Temperature (in ° C.) | R′ | 70 | 125 | 120 |
| Mixers R1-R5 | Temperature (in ° C.) | R1 | 75 | 135 | 75 |
| | | R2 | 80 | 135 | 80 |
| | | R3 | 85 | 135 | 85 |
| | | R4 | 90 | 135 | 90 |
| | | R5 | 95 | 110 | 95 |
| | Pressure (in bar) | Before R′ | 13 | 19.0 | 21.9 |
| | | After R5 | 1.3 | 9.0 | 8.0 |
| Mixer X′ | Mass flow (in g/h) | MIBK/Proglyme | 150.2 | 300.3 | 150.5 |
| Mixer X1 | Mass flow (in g/h) | Water | 1237 | 2450 | 1237.0 |
| | | 25 wt.-% aqueous | 39.7 | 79.8 | 39.8 |
| | | NaOH | | | |
| | | 9 wt.-% aqueous | 136 | 136 | 136.2 |
| | | DETA | | | |

1. A process for producing an aqueous polyurethane dispersion of a polyurethane having carboxyl groups, said method comprising
i. providing a liquid mixture of polyol compounds consisting essentially of
a) at least one aliphatic diol compound a) bearing at least one carboxyl group;
b) at least one polymeric polyol compound b) having on average from 1.5 to 2.5 hydroxyl groups per molecule;
c) optionally one or more further active hydrogen compounds c) which are different from the compounds a) and b);
wherein all components of the liquid mixture are present in mutually dissolved form;
ii. continuously feeding the liquid mixture of polyol compounds provided in step i. and at least one isocyanate compound having at least 2 isocyanate groups per molecule simultaneously into a continuously operated reactor under conditions, wherein a polyurethane having carboxyl groups is produced; and
iii. continuously discharging the polyurethane produced in step ii. from the reactor and continuously dispersing the polyurethane of step ii. in water.

2. The process of claim 1, wherein the compound a) is selected from the group consisting of bis(hydroxymethyl)alkanoic acids.

3. The process of claim 2, wherein the compound a) is selected from the group consisting of 2,2-bis(hydroxymethyl)propanoic acid, 2,2-bis(hydroxymethyl)butanoic acid and mixtures thereof.

4. The process of claim 1, wherein the amount of the component a) in the mixture is such that the mixture comprises 0.1 to 1 mol of carboxyl groups per kg of the mixture.

5. The process of claim 1, wherein the polymeric polyol has a number average molecular weight in a range of from 500 to 15,000 dalton, as determined by gel permeation chromatography.

6. The process of claim 1, wherein the polymeric polyol compound b) is selected from the group consisting of polyester polyols, aliphatic polycarbonate polyols, polyolefine polyols, aliphatic polyetherols and mixtures thereof.

7. The process of claim 1, wherein the isocyanate compound is selected from the group consisting of alicyclic diisocyanate compounds, aromatic diisocyanate compounds and mixtures thereof with aliphatic diisocyanate compounds.

8. The process of claim 1, wherein the liquid mixture of polyol compounds provided in step i. consists of at least 90% by weight, based on the total weight of the liquid mixture of compounds a) and b).

9. The process of claim 1, comprising at least one of the following features:
the liquid mixture of polyol compounds provided in step i. comprises less than 1% by weight of compounds having only one active hydrogen group;
step i. comprises mixing the compounds a), b) and optionally c) and heating the thus obtained mixture until the compounds are mutually dissolved in each other; and
the liquid mixture of polyol compounds provided in step i. and the at least one isocyanate compound are mixed in a static mixer followed by feeding the mixture into the continuously operated reactor.

10. The process of claim 1, wherein the reactor of step ii. is a tubular reactor.

11. The process of claim 10, wherein the reactor of step ii. has at least one of the following features:
the tubular reactor comprises at least one static mixing element located in the interior of the tubular reactor; and
the tubular reactor comprises at least two reaction zones operated at different temperatures, where the reaction zone adjacent to the feed is operated at a temperature which is at least 10 K lower than the temperature of the reaction zone adjacent to the discharge.

12. The process of claim 1, wherein step ii. is carried out at least initially in the absence of an organic solvent having no hydrogen active groups.

13. The process of claim 1, wherein dispersing the polyurethane in step iii. is carried out in the absence of an emulsifier.

14. The process of claim 1, wherein dispersing the polyurethane in step iii. is carried out in the presence of a base.

15. The process of claim 14, wherein the amount of base in emulsification of step iii. is such that at least 30% of the carboxyl groups of the polyurethane are neutralized.

16. The process of claim 1, further comprising a chain extension or crosslinking step iv. which is carried out after step iii.

17. The process of claim 2, wherein the compound a) is a mixture of 2,2-bis(hydroxymethyl)propanoic acid and 2,2-bis(hydroxymethyl)butanoic acid.

18. The process of claim 1, wherein the amount of the component a) in the mixture is such that the mixture comprises 0.25 to 0.8 mol of carboxyl groups per kg of the mixture.

19. The process of claim 1, wherein the polymeric polyol compound b) comprises a polyester polyol and/or an aliphatic polyether polyol.

20. The process of claim 1, wherein the isocyanate compound is selected from the group consisting of toluene diisocyanate, 4,4′-diisocyanatodiphenylmethan, bis(4-isocyanatocyclohexyl)methane, isophorone diisocyanate, mixtures thereof and mixtures thereof with hexamethylene diisocyanate.
